(19) United States
(12) Patent Application Publication
(10) Pub. No.: US 2013/0187924 A1
(43) Pub. Date: Jul. 25, 2013

(54) GRAPH DISPLAYING DEVICE

(71) Applicant: Azbil Corporation, Tokyo (JP)

(72) Inventor: Tomomi OGATA, Tokyo (JP)

(73) Assignee: AZBIL CORPORATION, Tokyo (JP)

(21) Appl. No.: 13/740,678

(22) Filed: Jan. 14, 2013

(30) Foreign Application Priority Data
Jan. 20, 2012 (JP) 2012-010138

(51) Int. Cl. G06T 11/20

(52) U.S. Cl. CPC G06T 11/206
USPC 345/440

(57) ABSTRACT

A graph displaying device includes a trend graph display that defines a time axis and a data value axis, and plots time series data in an orthogonal plane indicated by the axes to display a trend graph, a focus data pointer display that displays a pointer indicating a plot point relative to a selectively indicated plot point of the time series data when a desired plot point of the time series data has been selectively indicated on the trend graph, a focus data pointer moving/stopping unit that moves the pointer in a designated earlier or later direction on the time axis, and stops, at a plot point of the time series data, the pointer that has been moved, and a numeric value information display that displays a data value and a time mark at the plot point of the time series data.

### CROSS-REFERENCE TO RELATED APPLICATIONS

The present application claims priority to Japanese Patent Application No. 2012-010138 filed Jan. 20, 2012, the entire content of which being hereby incorporated herein by reference.

### FIELD OF TECHNOLOGY

The present invention relates to a graph displaying device for graphing and displaying time series data.

### BACKGROUND

Conventionally, in systems for monitoring and controlling the operation statuses of plants, and the like, pressures, fluid quantities, temperatures, and other measured values in the plant have been collected in time series, where the measured values (the time series data) collected in time series have been graphed and displayed on the screens of monitoring and controlling devices.

For example, with the horizontal axis as the time axis that indicates time marks, and the vertical axis, which is perpendicular to the time axis, as the data axis that indicates the data values, the time series data have been plotted on the orthogonal plane indicated by the time axis and the data axis, where the plotted time series data have been displayed on the screen as trend graphs.

In the trend graph displayed on the screen, if one wished to look at detailed numeric values of the individual data, one would use a method wherein one would move the mouse cursor to the location of the data to be looked at on the graph to display a “tooltip” (a pop-up window) that would appear at that location (See, for example, Japanese Unexamined Patent Application Publication 2001-242978), or would use a method wherein a hairline (a horizontal line, a vertical line, or both) would be moved to the location of the data through a mouse operation, to display data of that location in a data displaying region that is provided in the vicinity of the trend graph (See, for example, Japanese Unexamined Patent Application Publication H7-104968), or the like.

FIG. 24 shows an example (Conventional Example 1) wherein detailed numeric values for individual data are displayed through moving the mouse cursor to produce a tooltip. In this figure, X is the time axis and Y is the data axis, where time series data is plotted in the orthogonal plane indicated by the time axis X and the data axis Y, to display a trend graph G1 wherein the plotted time series data are connected by a line graph. In this trend graph G1, the mouse cursor 101 is moved to the location of data one wishes check on the graph, and a tooltip 102 is produced when the mouse is clicked, to display, as numeric value information, the time and data values at that location.

FIG. 25 shows an example (Conventional Example 2) wherein a hairline is moved to display detailed numeric values of individual data in a data display region. In this figure, 103 is a hairline comprising a horizontal line L 1 and a vertical line H1, and 104 is a numeric value displaying portion (data displaying region). In the trend graph G1, when the hairline 103 (the intersection P1 between the horizontal line Ll and the vertical line H1) is moved to the location of the desired data, through a mouse operation, the time and data values at that location are displayed in the numeric value displaying portion 104 as numeric value information.

In plant monitoring and control, there are cases wherein one wishes to confirm detailed numeric values of data for individual plot points while viewing overall trends in the data when displaying data of long time spans in trend graphs. However, when the time span is long, the data in the graph becomes densely concentrated (referencing FIG. 26 (a)), making it difficult to indicate data for individual plot points through mouse operations.

In such a case, in order to look at the data for the individual plot points, a portion of graph is enlarged and displayed in order to increase the distance between the data (referencing FIG. 26 (b)), but this causes only a portion of the entire data set to be displayed in the graph, making it difficult to understand the positioning of the data of the individual plot points relative to the overall trend. That is, it is difficult to understand the meanings of the numeric values and the magnitudes of deviations because it is not possible to see a picture of the entire data set.

Moreover, the operation for indicating the data for individual plot points using the mouse cursor or hairlines is inefficient, regardless of whether the time span is long or short. In particular, when the data collection period is irregular (referencing FIG. 27), it is difficult to know at a glance where the data for the next plot point will be located, making it difficult to check the data for the plot points without omissions.

### SUMMARY

The present invention was created in order to solve such problem areas, and an aspect of the present invention is to provide a graph displaying device that eliminates complicated and troublesome operations, in order to perform efficiently the operations for checking data of individual plot points on a trend graph with the entirety of the graph still displayed. Moreover, it is to provide a graph displaying device able to reduce omissions in checking through enabling reliable checking of data of plot points on the trend graph, without being aware of irregular data collection intervals.

The aspect of the present invention includes a trend graph display that defines a first axis as a time axis for indicating time marks, defines a second axis that is perpendicular to the first axis as a data axis for indicating data values, and plots time series data in an orthogonal plane indicated by the first axis and the second axis, to display the plotted time series data as a trend graph, a focus data pointer display that displays, as a focus data pointer, a pointer to indicate a plot point relative to a selectively indicated plot point of the time series data when a desired plot point of the time series data has been selectively indicated on the trend graph, a focus data pointer moving/stopping unit that receives an instruction from an operator for starting movement of the focus data pointer in a designated earlier or later direction on the time axis, moves the focus data pointer in the earlier or later direction, designated by the instruction, on the time axis, and stops, at a plot point of the time series data on the trend graph, the focus data pointer that has been moved, and a numeric value information display that displays as numeric value information a data value and a time mark at the plot point of the time series data indicated by the focus data pointer.

Given this invention, when a desired plot point of time series data in a trend graph is selectively indicated through a mouse operation, or the like, a focus data pointer that indicates and displays the selectively indicated plot point of the time series data is displayed. For example, a hairline may be displayed as the focus data pointer. Moreover, a data value and a time mark at the plot point of the time series data that is indicated and displayed by the focus data pointer are displayed as numeric value information together with displaying the focus data pointer.

In this invention, when, in a state wherein the focus data pointer is displayed, an instruction is issued by an operator to start movement, specifying the earlier or later direction on the time axis, the focus data pointer is moved, by this instruction, in the specified earlier or later direction on the time axis, and the moved focus data pointer stops at a plot point of the time series data on the trend graph. If, for example, the specified direction was the later direction on the time axis (the forward direction), then the focus data pointer moves in the later direction, to stop at a plot point in the time series data in the later direction. If the specified direction is the earlier direction on the time axis (the back direction), then the focus data pointer moves in the earlier direction, to stop at a point in the time series data in the earlier direction. When the focus data pointer stops at a plot point in the time series data, then the data value and time mark at that plot point in the time series data that is indicated and displayed by the focus data pointer are displayed as numeric value information.

In an example of the present invention, the focus data pointer moving/stopping unit may move the focus data pointer in the designated earlier/later direction on the time axis through an instruction from the operator to start movement, and the focus data pointer that has been moved is stopped at a plot point of the time series data in the trend graph, but as the system or moving/stopping the focus data pointer, one may consider a system wherein the focus data pointer that has been moved stops at the nearest plot point in the time series data on the trend graph, a system wherein the focus data pointer that has been moved stops sequentially, in the sequence of the time series, at plot points of the time series data on the trend graph, a system wherein the focus data pointer that has been moved stops, or stops sequentially, on plot points of the time series data in the trend graph following a prescribed rule, or the like.

In a system wherein the focus data pointer that has been moved stops at the nearest plot point in the time series data in the trend graph, each time an instruction is issued by an operator to begin movement, specifying the earlier or later direction on the time axis, the focus data pointer will move and stop automatically at the plot point in the time series data that is adjacent in the designated direction. In a system wherein the focus data pointer that has been moved stops sequentially, in the time series sequence, at plot points in the time series data on the trend graph, the focus data pointer will move and stop automatically at the next plot point in the time series data, which is adjacent in the designated direction, when an instruction for beginning movement, specifying the earlier or later direction on the time axis, is issued by an operator.

In a system wherein the focus data pointer that has been moved stops or sequentially stops on a plot point of the time series data in the trend graph following a prescribed rule, the focus data pointer stops automatically, or moves sequentially and stops automatically, on a plot point of the time series data, in the designated direction, in accordance with the prescribed rule when there is an instruction for starting movement, designating the earlier or later direction on the time axis, issued by an operator. In this case, one may consider a method wherein the prescribed rule is a prescribed time interval, an interval of a prescribed number of data points, a data value wherein a prescribed condition is true, or the like.

In a case wherein the prescribed rule is a prescribed time interval, the focus data pointer that has been moved is stopped sequentially at the nearest plot points in the time series data in the trend graph at the prescribed time intervals. In a case wherein the prescribed rule has an interval of a prescribed number of data points, the focus data pointer that has been moved is stopped sequentially at plot points in the time series data in the trend graph at intervals of the prescribed number of data points. In a case wherein the prescribed rule is that of data values for which a prescribed condition is true, then the focus data pointer that has been moved stops or stops sequentially at plot points having data values wherein the prescribed conditions are true in the time series data on the trend graph.

Given the present invention, when a desired plot point in time series data in a trend graph has been selectively indicated, a focus data pointer that indicates that plot points relative to a selectively indicated plot point in time series data is displayed, an instruction for starting movement for that focus data pointer, designating the earlier or later direction on the time axis, is received from an operator, the focus data pointer is moved in the earlier or later direction on the time axis, designated by that instruction, and the focus data pointer that has been moved is stopped at a plot point of the time series data on the trend graph, and, along with this, the data value and the time at the plot point of the time series data that is indicated by the focus data pointer are displayed as numeric value information, and thus the operator is able to selectively indicate a desired plot point in time series data on a trend graph to display a focus data pointer and not only assert an instruction to begin movement, designating the earlier or later direction on the time axis, but also, thereafter, the focus data pointer will move and stop automatically at plot points in the time series data on the trend graph, making it possible to eliminate complex and troublesome operations and to perform efficiently the checking operations for data for individual plot points on the trend graph while still displaying the graph as a whole.

Moreover, given the present invention the focus data pointer moves and stops automatically at a plot point of the time series data on the trend graph, making it possible to check reliably plot point data on the trend graph without being aware of irregular data collection intervals, making it possible to reduce omissions in checking.

### BRIEF DESCRIPTIONS OF THE DRAWINGS

FIG. 1 is a system configuration diagram illustrating schematically an example of a process monitoring/controlling system that includes the graph displaying device according to the present invention.

FIG. 2 is a block diagram illustrating the configuration of the key portions of a server device in this process monitoring/controlling system.

FIG. 3 is a block diagram illustrating schematically the hardware configuration of the monitoring/controlling device in the process monitoring/controlling system.

FIG. 4 is a diagram illustrating an example display of a trend graph on the display of the monitoring/controlling device.

FIG. 5 is a diagram illustrating an example display of a hairline (a focus data pointer) for positioning a mouse cursor on a desired plot point on a trend graph.

FIG. 6 is a diagram for explaining an example of moving the hairline one plot point at a time to an adjacent plot point (an example of moving in the later direction (the forward direction) on the time axis).

FIG. 7 is a diagram for explaining an example of moving the hairline one plot point at a time to an adjacent plot point (an example of moving in the earlier direction (the back direction) on the time axis).

FIG. 8 is a diagram for explaining an example of moving the hairline automatically to sequentially adjacent plot points (an example of moving in the later direction on the time axis).

FIG. 9 is a diagram for explaining an example of moving the hairline automatically to sequentially adjacent plot points (an example of moving in the earlier direction on the time axis).

FIG. 10 is a diagram illustrating an example display of a hairline for positioning a mouse cursor on a desired plot point on a trend graph.

FIG. 11 is a diagram for explaining an example of moving the focus data pointer automatically sequentially to the nearest plot points at prescribed time intervals (an example of movement in the later direction on the time axis).

FIG. 12 is a diagram for explaining an example of moving the focus data pointer automatically sequentially to the nearest plot points at prescribed time intervals (an example of movement in the earlier direction on the time axis).

FIG. 13 is a diagram for explaining an example of moving the focus data pointer automatically sequentially to the plot points at intervals of a prescribed number of data points (an example of movement in the later direction on the time axis).

FIG. 14 is a diagram for explaining an example of moving the focus data pointer automatically sequentially to the plot points at intervals of a prescribed number of data points (an example of movement in the earlier direction on the time axis).

FIG. 15 is a diagram for explaining an example of moving the focus data pointer automatically sequentially to plot points with data values matching prescribed conditions (an example of movement in the later direction on the time axis).

FIG. 16 is a diagram for explaining an example of moving the focus data pointer automatically sequentially to plot points with data values matching prescribed conditions (an example of movement in the earlier direction on the time axis).

FIG. 17 is a diagram illustrating an example of displaying a hairline relative to a plot point at a time mark that is nearest to a time mark that has been inputted into a time mark inputting portion.

FIG. 18 is a diagram illustrating an example of moving a hairline relative to a plot point at a time mark that is nearest to a time mark that has been inputted into a time mark inputting portion.

FIG. 19 is a diagram illustrating another example of a focus data pointer.

FIG. 20 is a diagram illustrating an example wherein a plurality of trend graphs is displayed.

FIG. 21 is a diagram illustrating an example wherein a tooltip is displayed within a graph portion as a numeric value displaying portion.

FIG. 22 is a diagram illustrating an example wherein a screen that is separate from the trend graph display screen is displayed as a numeric value displaying portion.

FIG. 23 is a functional block diagram of the monitoring/controlling device.

FIG. 24 is a diagram for explaining a first conventional example when looking at detailed numeric values of individual data on a trend graph.

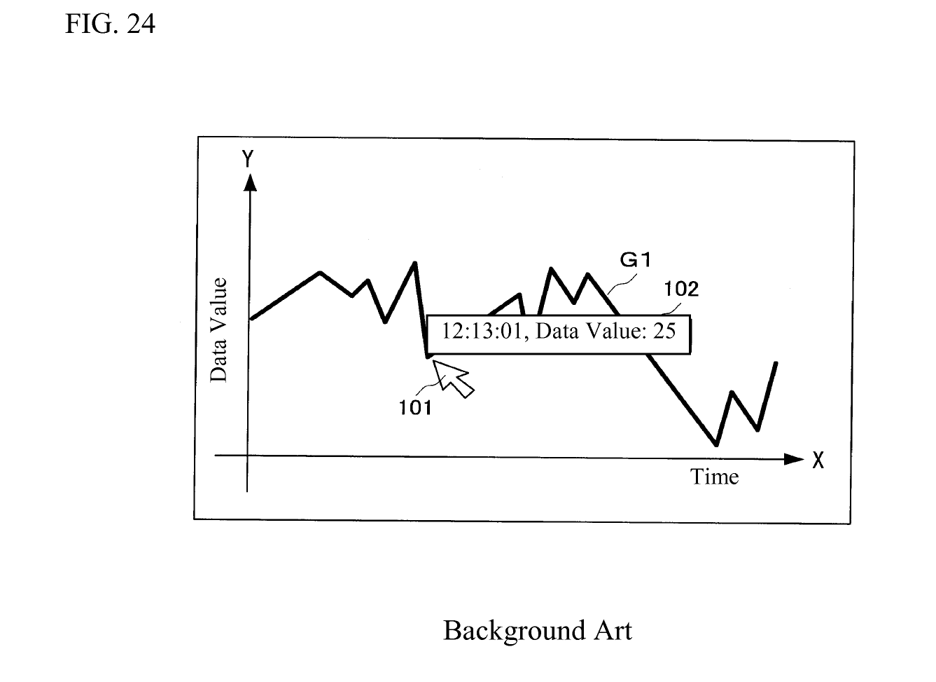

FIG. 25 is a diagram for explaining a second conventional example when looking at detailed numeric values of individual data on a trend graph.

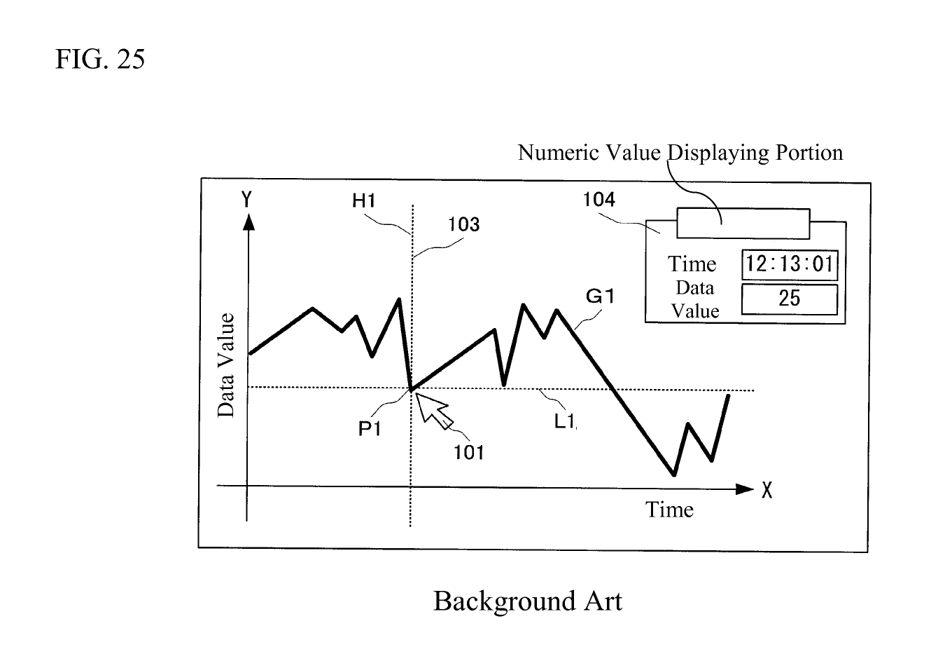

FIG. 26 is a diagram illustrating a trend graph wherein the time span is long.

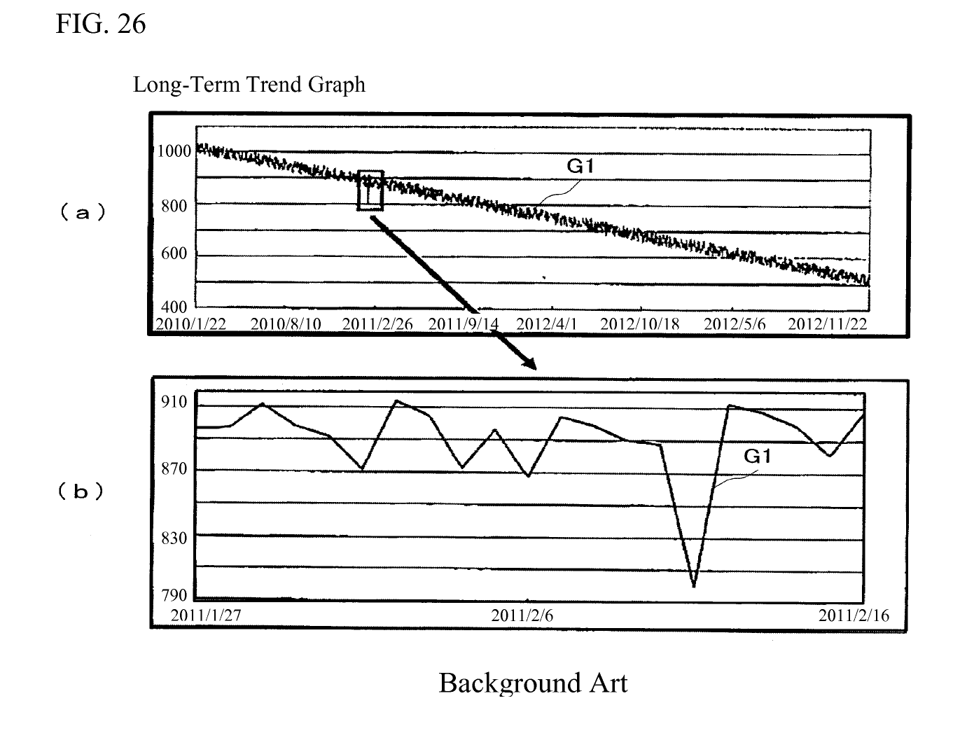

FIG. 27 is a diagram illustrating a trend graph wherein the data collecting period is irregular.

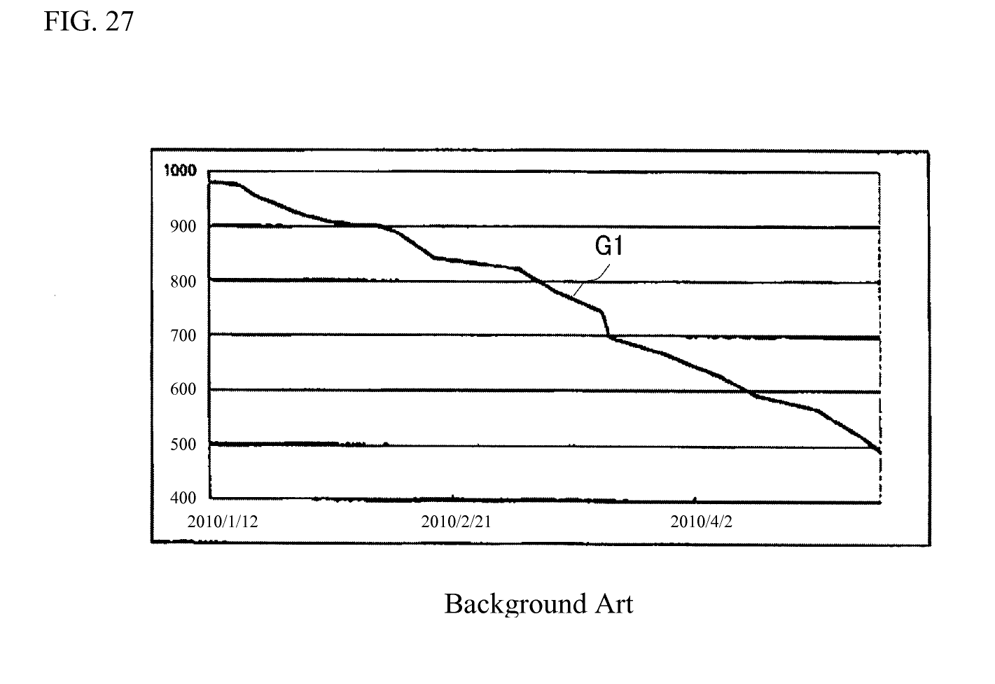

### DETAILED DESCRIPTION

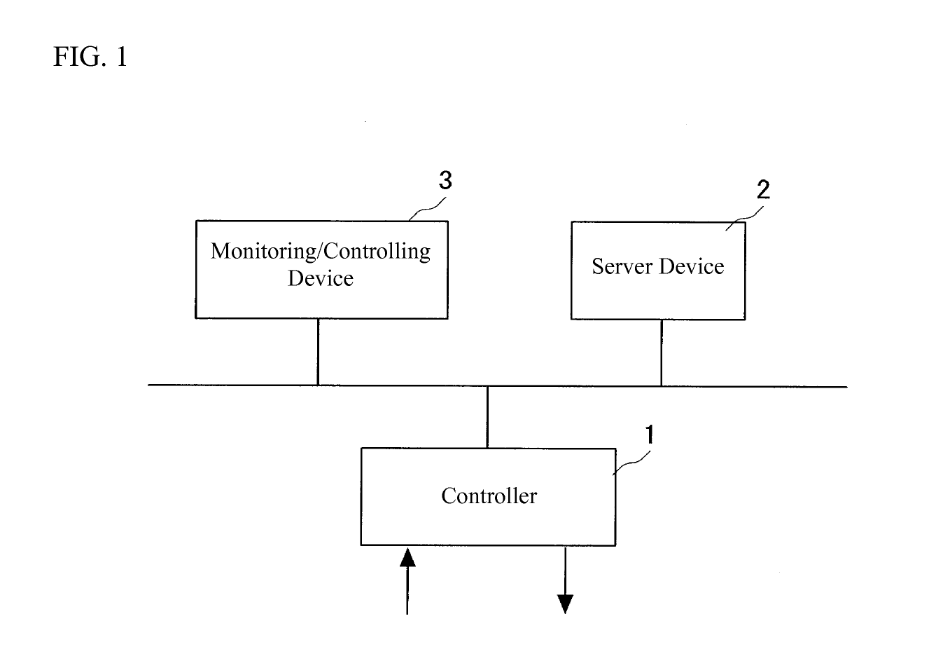

The present invention will be explained in detail below based on the drawings. FIG. 1 is a system configuration diagram illustrating schematically an example of a process monitoring/controlling system that includes the graph displaying device according to the present invention.

This process monitoring/controlling system controls a field device (for example, a switch, a valve, a pump, a pressure meter, a flow rate meter, a thermometer, or the like), not shown, that is disposed within a plant, and is structured from: a controller 1 that collects, in a time series, measured values for, for example, a pressure, a flow rate, a temperature, or the like, from the field device; a server device 2 for acquiring, periodically, the measured values (the time series data) collected in time series by the controller 1; and a monitoring/controlling device 3 for applying instructions to the controller 1 and the server device 2 in accordance with operator instructions, and for editing/creating plant monitoring/controlling screens.

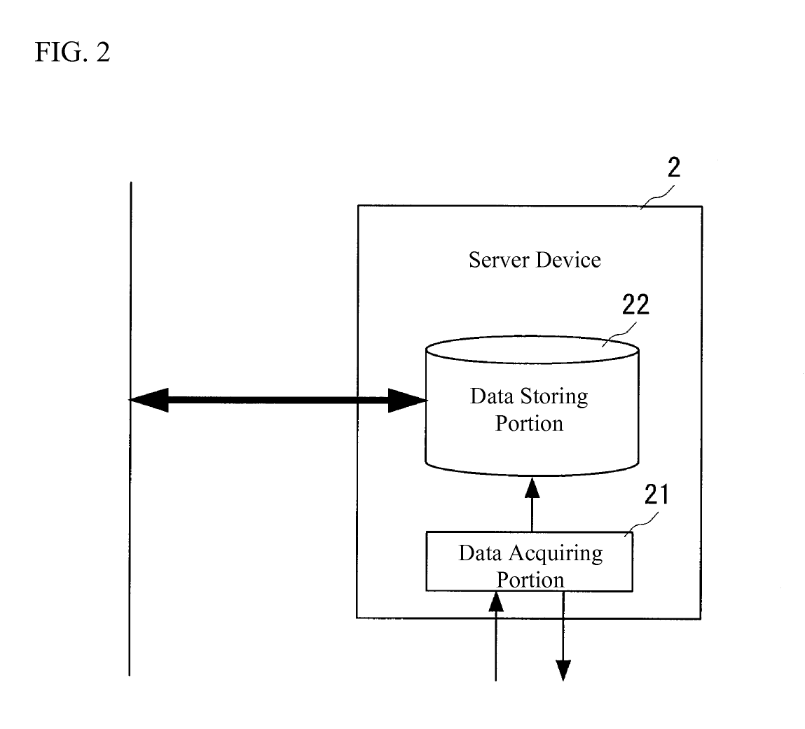

FIG. 2 is a block diagram illustrating the configuration of key portions of the server device 2. The server device 2 has a data acquiring portion 21 for acquiring periodically time series data of the field device from the controller 1, and a data storing portion 22 for storing the time series data that has been acquired. Note that the time series data stores, in the data storing portion, the data values paired with time marks that are the times at which the data were collected.

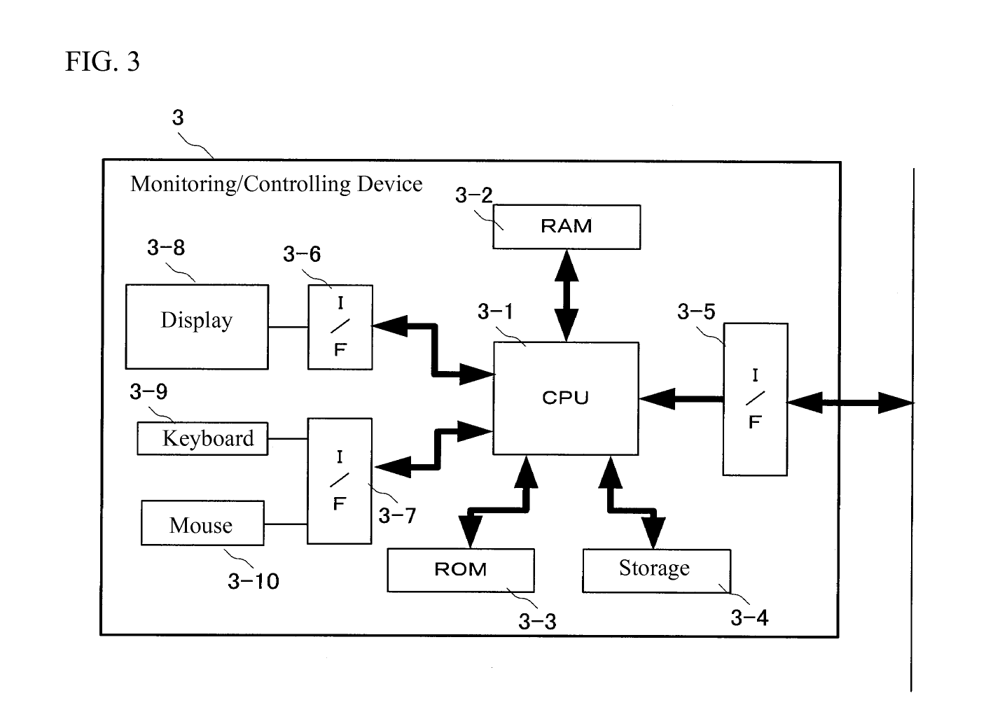

FIG. 3 is a block diagram illustrating schematically the hardware configuration of the monitoring/controlling device 3. In this figure, 3-1 is a CPU, 3-2 is a RAM, 3-3 is a ROM, 3-4 is a storage device such as a hard disk, or the like, 3-5 through 3-7 are interfaces, 3-8 is a display, 3-9 is a keyboard, and 3-10 is a mouse.

The CPU 3-1 operates in accordance with a program that is stored in the ROM 3-3 or in the storage device 3-4, while obtaining various types of inputted data asserted through the interfaces 3-5 and 3-7 and while accessing the RAM 3-2. The storage device 3-4 stores, as a program that is unique to the present example, a trend graph displaying program. This trend graph displaying program is provided in a state wherein it is recorded on a recording medium, such as, for example, a CD-ROM, or the like, and read out from that recording medium and installed in the storage device 3-4.

Note that while in this example a server device 2 and a monitoring/controlling device 3 are provided separately, these may instead be combined. Moreover, the server device 2 and the controller 1 may be combined, or the like.

Example Wherein the Hairline is Moved One Plot Point at a Time to the Adjacent Plot Point

Example of the processing operations of the CPU 3-1 in accordance with a trend graph displaying program that is stored in the storage device 3-4 will be explained below.

Displaying a Trend Graph

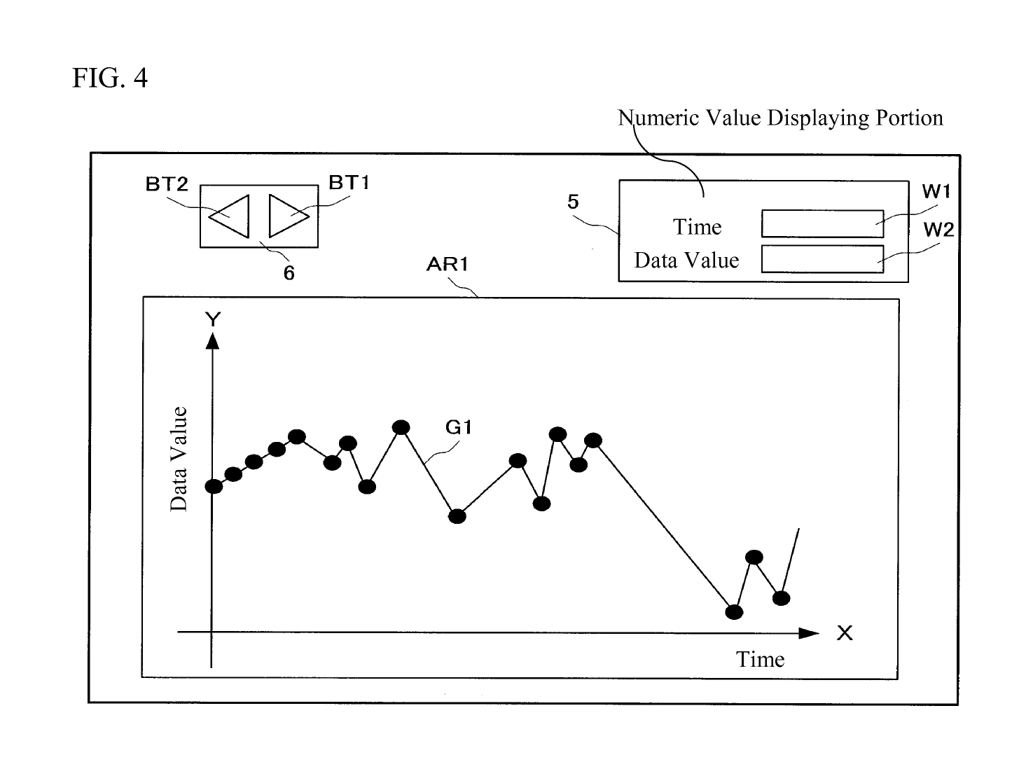

When an operator has issued, as a request, a request for displaying a trend graph, specifying a measurement point and an interval, the CPU 3-1, based on the specified measurement point, acquires, from the data storing portion 22 of the server device 2, time series data for the specified interval, and graphs the acquired time series data to display it on the display 3-8. FIG. 4 shows an example display for the time series data on the display 3-8.

In this case, the CPU 3-1 uses the horizontal axis as a time axis X for representing the time and uses the vertical axis, which is perpendicular to the time axis X, as a data axis Y for representing the data values, and plots the time series data for the specified measurement point in the orthogonal plane indicated by the time axis X and the data axis Y, to display, on the display 3-8, as a trend graph G1, by connecting, through graph lines, the time series data that have been plotted (points indicated by the black circles).

Moreover, the CPU 3-1 displays, in the display screen for the trend graph G1, a numeric value displaying portion 5 and an operating portion 6. A display window W1 for the time marks and a display window W2 for the data values are provided in the numeric value displaying portion 5. A right-facing arrow button (a Forward button) BT1 and a left-facing arrow button (a Back button) BT2 are provided in the operating portion 6.

Displaying the Hairline

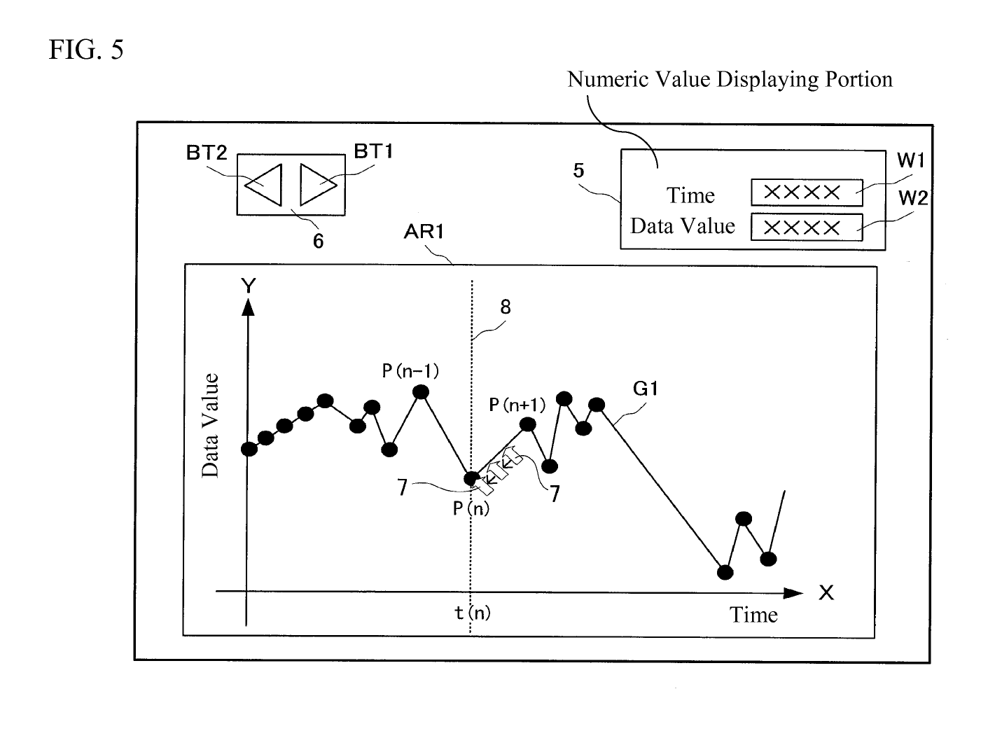

When wishing to look at detailed numeric values for the data for the individual plot points, the operator operates the mouse 3-10 in the trend graph G1 to position the mouse cursor 7 at the location wherein the desired plot point exists (referencing FIG. 5). FIG. 5 shows an example wherein the desired plot point is assumed to be P(n), so the mouse cursor 7 that is located between the plot point P(n) and P(n+1) is moved, to approach the plot point P(n). In FIG. 5, P(n+1) indicates a plot point that is one plot point later than P(n) on the time axis X, and P(n−1) indicates a plot point that is one plot point earlier than P(n) on the time axis X.

When the mouse cursor 7 approaches the plot point P(n), and the CPU 3-1 detects that the mouse cursor is at a location wherein the plot point P(n) exists, that is, when the CPU 3-1 recognizes the selective indication of the plot point P(n), the CPU 3-1 displays the hairline 8, as a pointer indicating that plot point, for the plot point P(n). This hairline 8 is the “focus data pointer referred to in the present invention. In the present example, the hairline 8 is a vertical line.

Moreover, at the same time as displaying the hairline 8, the CPU 3-1 displays the data value and the time mark at the plot point P(n) that is indicated by the hairline 8 as numeric value information in the numeric value displaying portion 5. In this case, the time mark is displayed in the display window W1 and the data value is displayed in the display window W2.

Here the operator, through displaying the hairline 8, has selectively indicated the plot point P(n) that is indicated by the hairline 8, and knows that the numeric value information displayed in the numeric value displaying portion 5 is numeric value information for the selectively indicated plot point P(n). As a result, the operator is able to check reliably the detailed information for the data of the selected plot point P(n) by selecting the desired plot point P(n) in the trend graph G1.

Note that while in this example the mouse cursor 7, located between the plot points P(n) and P(n+1) was brought close to the plot point P(n), instead the hairline 8 may be displayed automatically when at an earlier or later plot point in the immediate vicinity of the mouse cursor 7 when the mouse cursor 7 is between the plot points P(n) and P(n+1). In this case, when the mouse cursor 7 is located closer to the plot point P(n) than the plot point P(n+1), the CPU 3-1 would detect the location of the mouse cursor 7 as being at the location wherein the plot point P(n) exists, and automatically display the hairline 8 for the plot point P(n).

Moving the Hairline

When the operator wishes to look at detailed information for the data for the next plot point, the operator performs a mouse click on the Forward button BT1 or the Back button BT2 of the operating portion 6. For example, if the operator wishes to look at detailed data for the plot point P(n+1), the operator would perform a mouse click on the Forward button BT1, but if the operator wishes to look at detailed information for the data of the plot point P(n−1), the operator would perform a mouse click on the Back button BT2.

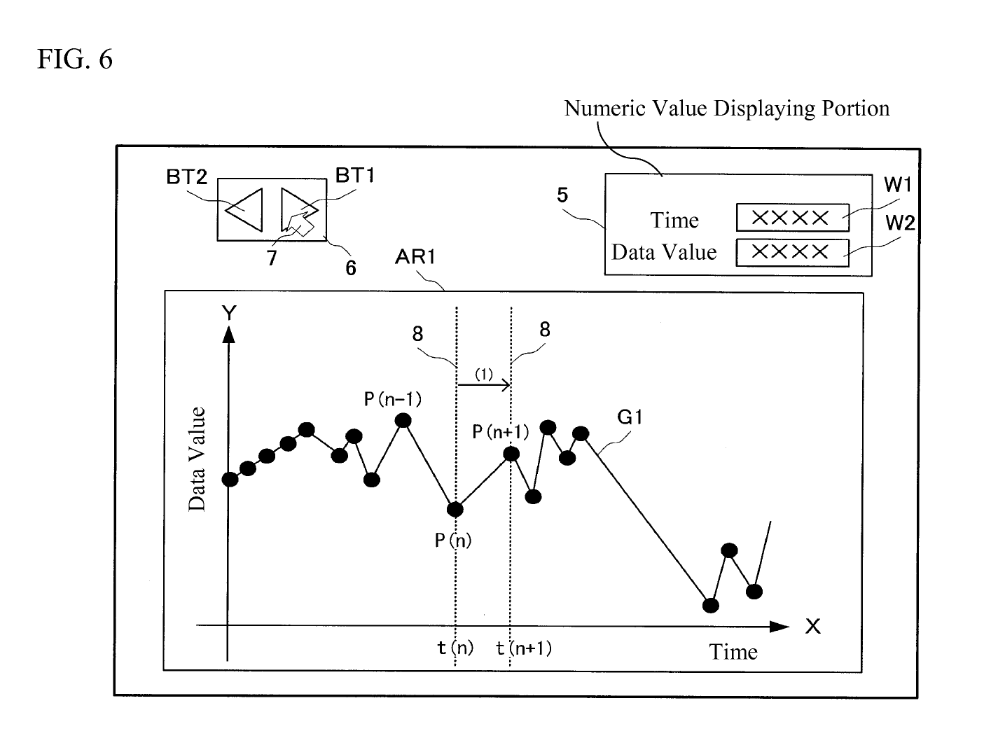

When there is a mouse click on the Forward button BT1, then the CPU 3-1 detects this as an instruction from the operator to begin moving the hairline 8, specifying the later direction on the time axis X, and moves the hairline 8 in the later direction on the time axis X, specified by this instruction, and the hairline 8, which has been moved, is stopped at the nearest plot point P(n+1) of the time series data (referencing arrow (1) shown in FIG. 6). Moreover, simultaneously with stopping the hairline 8, the data value and time mark at the plot point P(n+1) that is specified by the hairline 8 is displayed as numeric value information in the numeric value displaying portion 5.

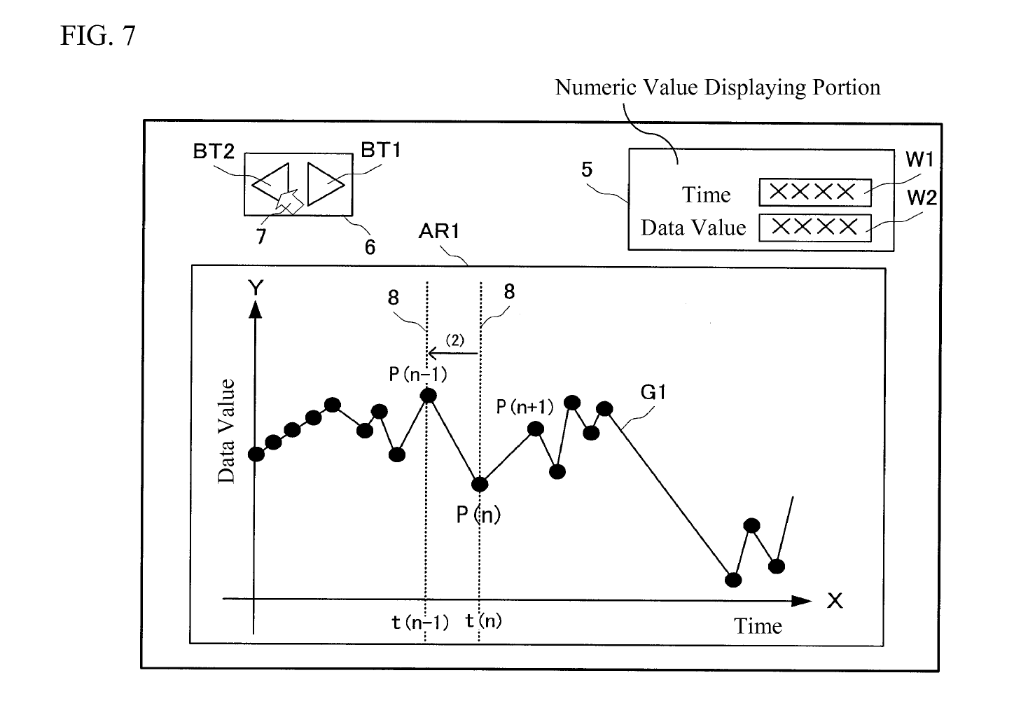

When there is a mouse click on the Back button BT2, then the CPU 3-1 detects this as an instruction from the operator to begin moving the hairline 8, specifying the earlier direction on the time axis X, and moves the hairline 8 in the earlier direction on the time axis X, specified by this instruction, and the hairline 8, which has been moved, is stopped at the nearest plot point P(n−1) of the time series data (referencing arrow (2) shown in FIG. 7). Moreover, simultaneously with stopping the hairline 8, the data value and time mark at the plot point P(n−1) that is specified by the hairline 8 is displayed as numeric value information in the numeric value displaying portion 5.

Following this, similarly, each time the Forward button BT1 is pressed, the CPU 3-1 moves the hairline 8 in the later direction on the time axis X, and stops it on the adjacent plot point in the time series data, and each time the Back button BT2 is pressed, the CPU 3-1 moves the hairline 8 in the earlier direction on the time axis X, and stops it on the adjacent plot point in the time series data. Moreover, the data value and time mark at the plot point wherein the hairline 8 is stopped are displayed as numeric value information in the numeric value displaying portion 5.

Another Example Wherein the Hairline is Moved Automatically Sequentially to Adjacent Plot Points

Another Example of the processing operations of the CPU 3-1 in accordance with a trend graph displaying program that is stored in the storage device 3-4 will be explained next. Note that the “Displaying the Trend Graph” and “Displaying the Hairline” are the same as in the Example, so explanations thereof are omitted.

Moving the Hairline

When, in FIG. 5, the operator wishes to look at detailed information for the data for the next plot point, the operator performs a mouse click on the Forward button BT1 or the Back button BT2 of the operating portion 6. For example, if the operator wishes to look at detailed data for the individual plot points in the later direction on the time axis X, the operator would perform a mouse click on the Forward button BT1, but if the operator wishes to look at detailed information for the data of the individual plot points in the earlier direction on the time axis X, the operator would perform a mouse click on the Back button BT2.

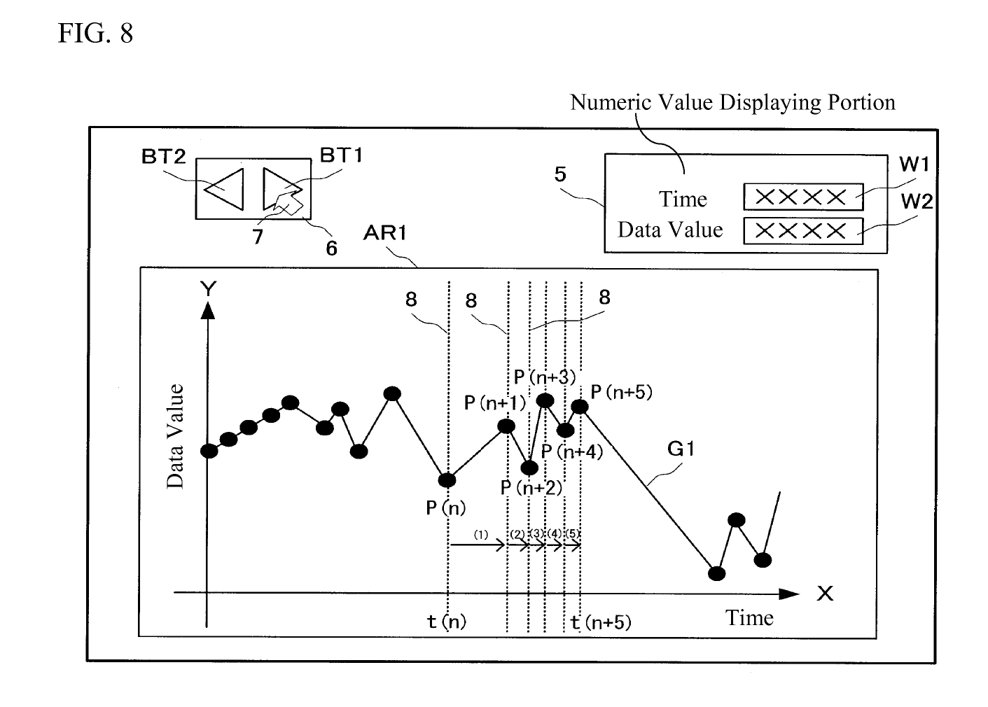

When there is a mouse click on the Forward button BT1, then the CPU 3-1 detects this as an instruction from the operator to begin moving the hairline 8, specifying the later direction on the time axis X, and moves the hairline 8 in the later direction on the time axis X, specified by this instruction, and the hairline 8, which has been moved, is stopped at the nearest plot point P(n +1) of the time series data (referencing arrow (1) shown in FIG. 8). Moreover, simultaneously with stopping the hairline 8, the data value and time mark at the plot point P(n+1) that is specified by the hairline 8 is displayed as numeric value information in the numeric value displaying portion 5.

Given this, after a prescribed waiting time has elapsed, the hairline 8 again moves in the later direction on the time axis X, and the hairline 8, which has been moved, is stopped at the plot point P(n+2) for the nearest time series data (referencing Arrow (2) in FIG. 8). Moreover, simultaneously with stopping the hairline 8, the data value and time mark at the plot point P(n+2) that is specified by the hairline 8 is displayed as numeric value information in the numeric value displaying portion 5.

Similarly, thereafter, each time the prescribed waiting time elapses, the CPU 3-1 moves the hairline 8 in the later direction on the time axis X, to stop it sequentially at the adjacent plot point. Moreover, at each of the stop locations for the hairline 8, the data value and the time mark at the plot points wherein the hairline 8 is stopped are displayed as numeric value information in the numeric value displaying portion 5.

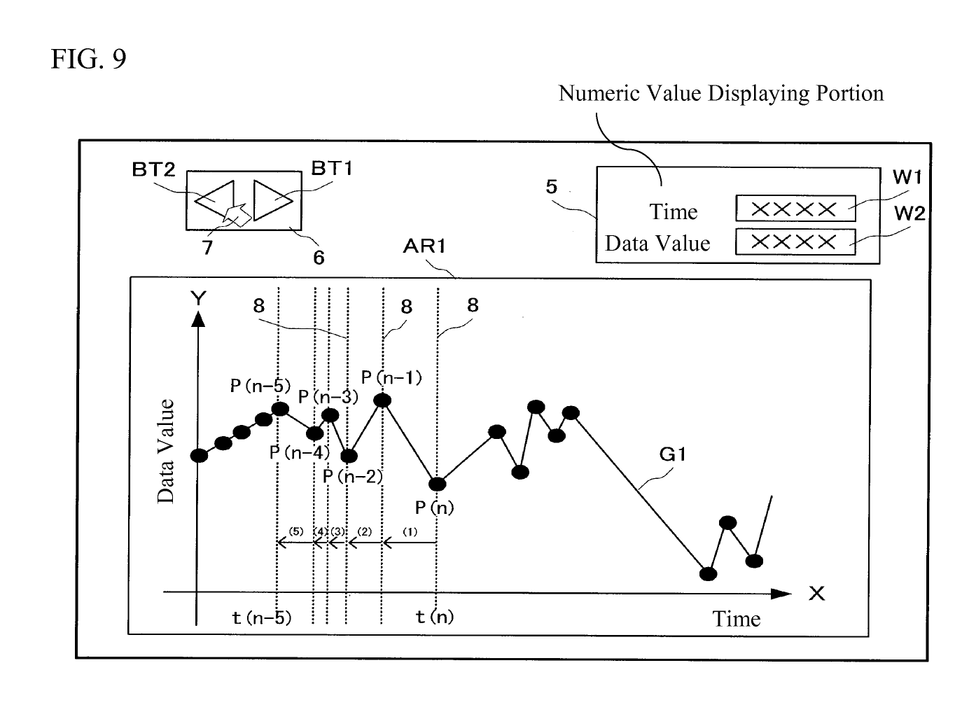

When there is a mouse click on the Back button BT2, then the CPU 3-1 detects this as an instruction from the operator to begin moving the hairline 8, specifying the earlier direction on the time axis X, and moves the hairline 8 in the earlier direction on the time axis X, specified by this instruction, and the hairline 8, which has been moved, is stopped at the nearest plot point P(n−1) of the time series data (referencing arrow (1) shown in FIG. 9). Moreover, simultaneously with stopping the hairline 8, the data value and time mark at the plot point P(n−1) that is specified by the hairline 8 is displayed as numeric value information in the numeric value displaying portion 5.

Given this, after a prescribed waiting time has elapsed, the hairline 8 again moves in the earlier direction on the time axis X, and the hairline 8, which has been moved, is stopped at the plot point P(n−2) for the nearest time series data (referencing Arrow (2) in FIG. 9). Moreover, simultaneously with stopping the hairline 8, the data value and time mark at the plot point P(n−2) that is specified by the hairline 8 is displayed as numeric value information in the numeric value displaying portion 5.

Similarly, thereafter, each time the prescribed waiting time elapses, the CPU 3-1 moves the hairline 8 in the earlier direction on the time axis X, to stop it sequentially at the adjacent plot point. Moreover, at each of the stop locations for the hairline 8, the data value and the time mark at the plot points wherein the hairline 8 is stopped are displayed as numeric value information in the numeric value displaying portion 5.

In this way, in the Another Example, the hairline 8 is moved in the designated direction on the time axis automatically through a simple mouse click on the Forward button BT1 or Back button BT2, and the hairline 8, which has been moved, sequentially stops, in time-series order, on each of the plot points in the designated direction on the time axis X, where the data value and the time mark at the plot point wherein the hairline 8 is stopped are displayed as numeric value information in the numeric value displaying portion 5. In this case, it is possible to dynamically understand the movements of the plot points in the trend graph G1 while observing an overall image of the trend graph G1.

Yet Another Example Wherein the Hairline is Moved Automatically Sequentially to the Nearest Plot Points at Prescribed Time Intervals

Yet Another Example of the processing operations of the CPU 3-1 in accordance with a trend graph displaying program that is stored in the storage device 3-4 will be explained next. Note that the “Displaying the Trend Graph” and “Displaying the Hairline” are the same as in the Example, so explanations thereof are omitted.

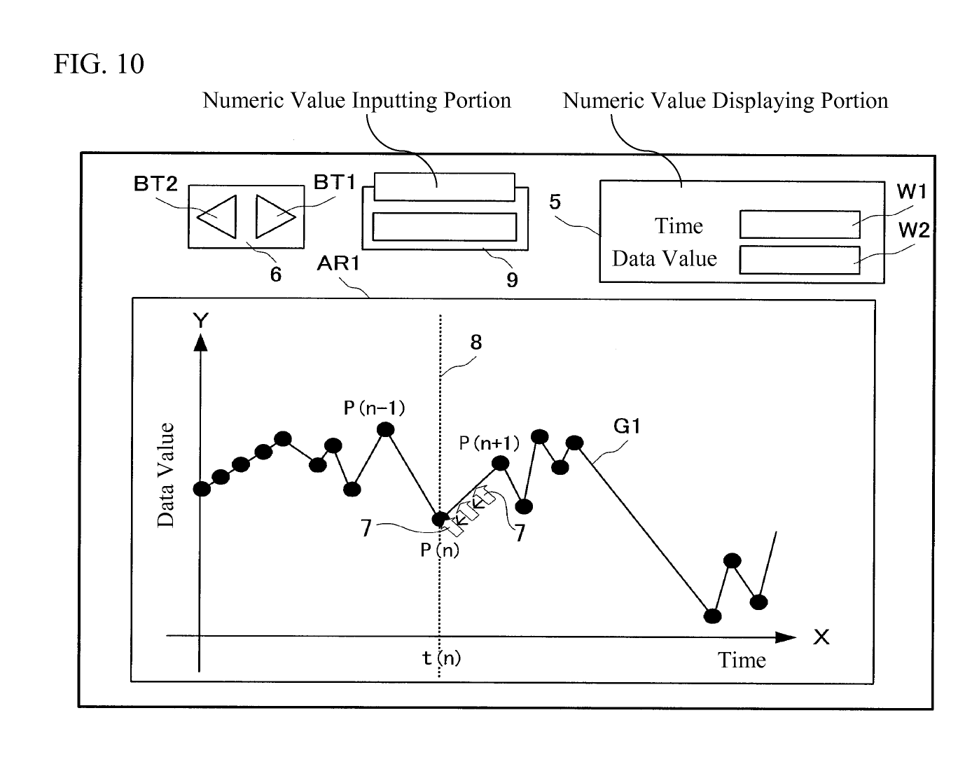

Note that in this Yet Another Example, as illustrated in FIG. 10, which corresponds to FIG. 5, a numeric value inputting portion 9 is displayed in the display screen for the trend graph G1. This numeric value inputting portion 9 corresponds to the condition inputting portion for specifying the rule designated by the operator in terms of the present invention.

Moving the Hairline

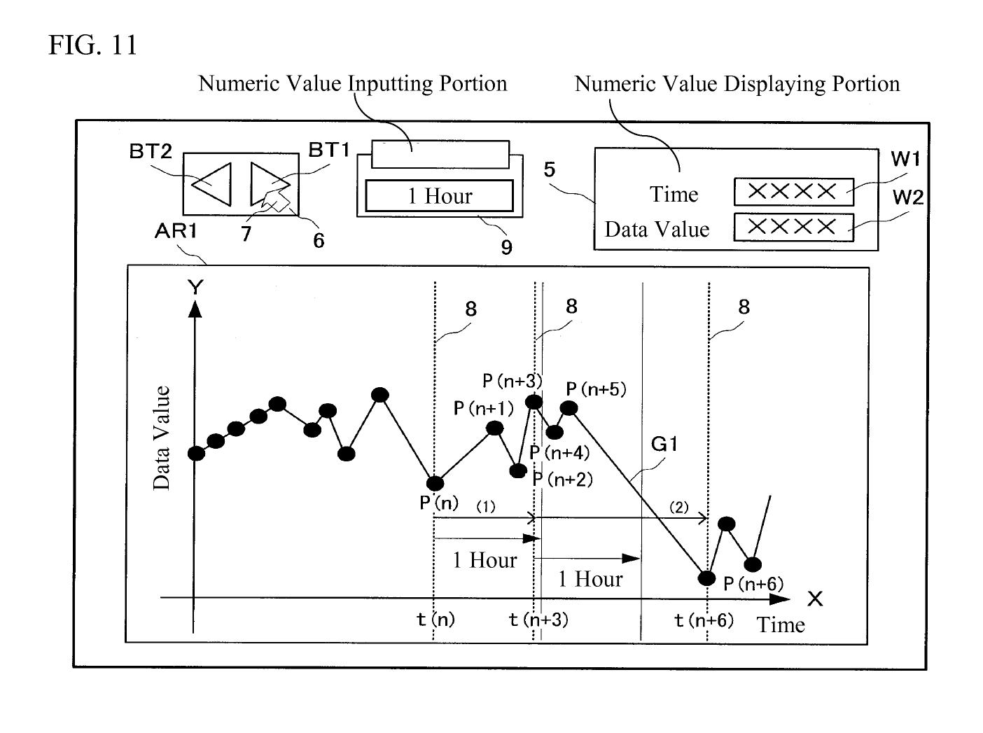

In FIG. 10, if the operator wishes to look at detailed information for the data for the next plot point, the operator inputs the desired time interval (for example, one hour) as the operator-designated rule (a “skip rule”) into the numeric value inputting portion 9 (referencing FIG. 11) and then performs a mouse click on the Forward button BT1 or the Back button BT2 of the operating portion 6.

For example, if the operator wishes to look at detailed data for the individual plot points in the later direction on the time axis X following the designated skip rule, the operator would perform a mouse click on the Forward button BT1, but if the operator wishes to look at detailed information for the data of the individual plot points in the earlier direction on the time axis X following the designated skip rule, the operator would perform a mouse click on the Back button BT2.

When there is a mouse click on the Forward button BT1, then the CPU 3-1 detects this as an instruction from the operator to begin moving the hairline 8, specifying the later direction on the time axis X, and moves the hairline 8 in the later direction on the time axis X, specified by this instruction.

While in this case the time interval that was set in the numeric value inputting portion 9 is used as the movement distance for the hairline 8, if there is no plot point in the time series data at that time interval, then the hairline 8 stops at the nearest plot point (a later plot point or earlier plot point) in the time series data (referencing Arrow (1) shown in FIG. 11). Moreover, simultaneously with stopping the hairline 8, the data value and time mark at the plot point that is specified by the hairline 8 is displayed as numeric value information in the numeric value displaying portion 5.

Given this, after the prescribed waiting time has elapsed, the hairline 8 is again moved in the later direction on the time axis X. In this case as well, the time interval that was set in the numeric value inputting portion 9 is used as the movement distance for the hairline 8, and if there is no plot point in the time series data at that time interval, then the hairline 8 stops at the nearest plot point (a later plot point or earlier plot point) in the time series data (referencing Arrow (2) shown in FIG. 11). Moreover, simultaneously with stopping the hairline 8, the data value and time mark at the plot point that is specified by the hairline 8 is displayed as numeric value information in the numeric value displaying portion 5.

Similarly, thereafter, each time the prescribed waiting time elapses, the CPU 3-1 moves the hairline 8 in the later direction on the time axis X by the time interval set in the numeric value inputting portion 9, to stop it sequentially at the nearest plot points. Moreover, at each of the stop locations for the hairline 8, the data value and the time mark at the plot points wherein the hairline 8 is stopped are displayed as numeric value information in the numeric value displaying portion 5.

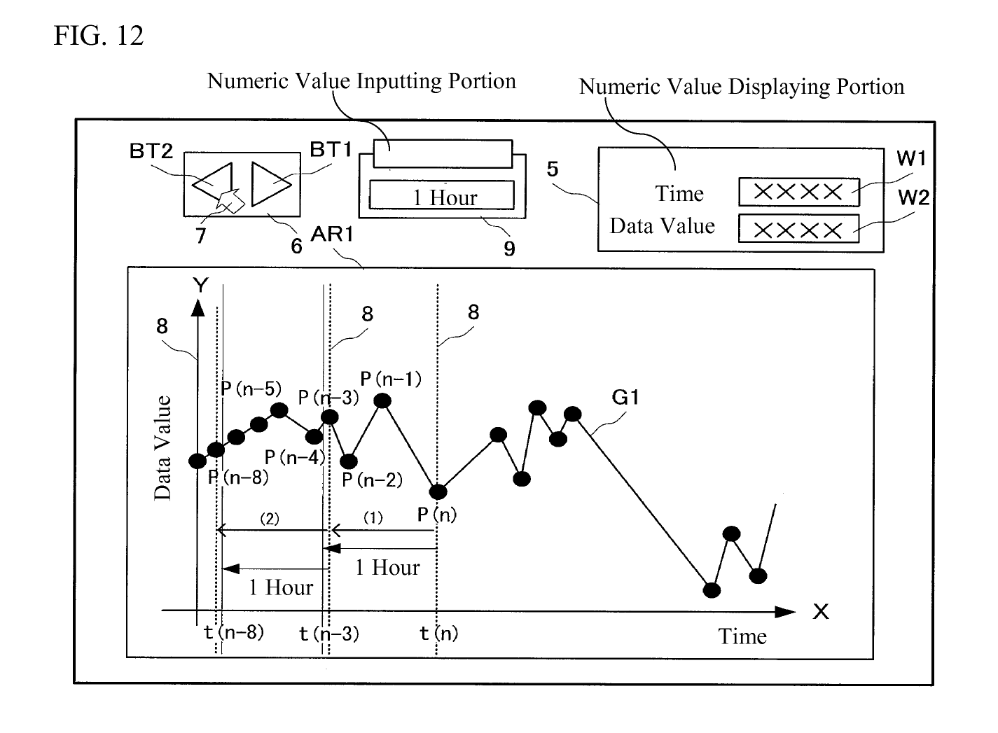

When there is a mouse click on the Back button BT2, then the CPU 3-1 detects this as an instruction from the operator to begin moving the hairline 8, specifying the earlier direction on the time axis X, and moves the hairline 8 in the earlier direction on the time axis X, specified by this instruction. While in this case the time interval that was set in the numeric value inputting portion 9 is used as the movement distance for the hairline 8, if there is no plot point in the time series data at that time interval, then the hairline 8 stops at the nearest plot point (a later plot point or earlier plot point) in the time series data (referencing Arrow (1) shown in FIG. 12). Moreover, simultaneously with stopping the hairline 8, the data value and time mark at the plot point that is specified by the hairline 8 is displayed as numeric value information in the numeric value displaying portion 5.

Given this, after the prescribed waiting time has elapsed, the hairline 8 is again moved in the earlier direction on the time axis X. In this case as well, the time interval that was set in the numeric value inputting portion 9 is used as the movement distance for the hairline 8, and if there is no plot point in the time series data at that time interval, then the hairline 8 stops at the nearest plot point (a later plot point or earlier plot point) in the time series data (referencing Arrow (2) shown in FIG. 12). Moreover, simultaneously with stopping the hairline 8, the data value and time mark at the plot point that is specified by the hairline 8 is displayed as numeric value information in the numeric value displaying portion 5.

Similarly, thereafter, each time the prescribed waiting time elapses, the CPU 3-1 moves the hairline 8 in the earlier direction on the time axis X by the time interval set in the numeric value inputting portion 9, to stop it sequentially at the nearest plot points. Moreover, at each of the stop locations for the hairline 8, the data value and the time mark at the plot points wherein the hairline 8 is stopped are displayed as numeric value information in the numeric value displaying portion 5.

In this way, in the Yet Another Example, the hairline 8 is moved in the designated direction on the time axis automatically, by the time interval set in the numeric value inputting portion 9, through a simple mouse click on the Forward button BT1 or Back button BT2, and the hairline 8, which has been moved, sequentially stops at the nearest plot points in the designated direction on the time axis X, where the data value and the time mark at the plot point wherein the hairline 8 is stopped are displayed as numeric value information in the numeric value displaying portion 5. In this case, it is possible to dynamically understand the movements of the plot points at the time interval that has been set in the trend graph G1 while observing an overall image of the trend graph G1.

Further Example Wherein the Hairline is Moved Automatically Sequentially to the Nearest Plot Points at Intervals of a Prescribed Number of Data Points

A Further Example of the processing operations of the CPU 3-1 in accordance with a trend graph displaying program that is stored in the storage device 3-4 will be explained next. Note that in this Further Example as well, the “Displaying the Trend Graph” and “Displaying the Hairline” are the same as in the Example, so explanations thereof are omitted. Moreover, as with the Yet Another Example, a numeric value inputting portion 9 is displayed in the display screen for the trend graph G1 (FIG. 10).

Moving the Hairline

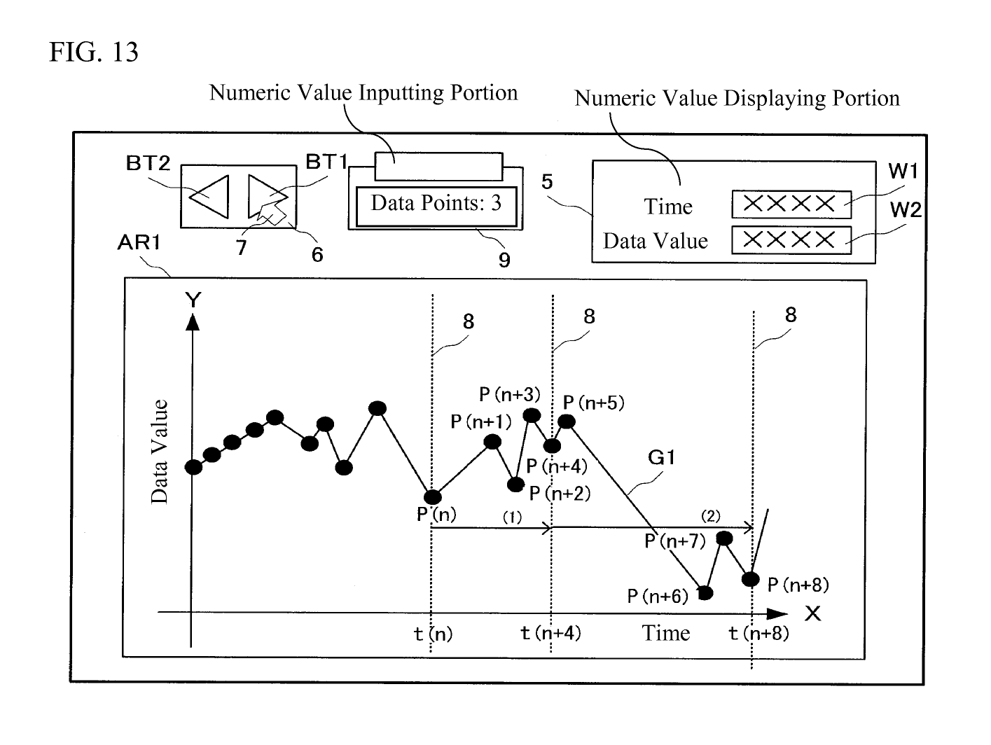

In FIG. 10, if the operator wishes to look at detailed information for the data for the next plot point, the operator inputs the desired data point count interval (for example, three data points) as the operator-designated rule (a “skip rule”) into the numeric value inputting portion 10 (referencing FIG. 13) and then performs a mouse click on the Forward button BT1 or the Back button BT2 of the operating portion 6.

For example, if the operator wishes to look at detailed data for the individual plot points in the later direction on the time axis X following the designated skip rule, the operator would perform a mouse click on the Forward button BT1, but if the operator wishes to look at detailed information for the data of the individual plot points in the earlier direction on the time axis X following the designated skip rule, the operator would perform a mouse click on the Back button BT2.

When there is a mouse click on the Forward button BT1, then the CPU 3-1 detects this as an instruction from the operator to begin moving the hairline 8, specifying the later direction on the time axis X, and moves the hairline 8 in the later direction on the time axis X, specified by this instruction. In this case, the data point count interval that was set in the numeric value inputting portion 10 is used as the movement distance for the hairline 8, and the hairline 8 stops at the plot point after the interval of that number of data points (referencing Arrow (1) shown in FIG. 13). Moreover, simultaneously with stopping the hairline 8, the data value and time mark at the plot point that is specified by the hairline 8 is displayed as numeric value information in the numeric value displaying portion 5.

Given this, after the prescribed waiting time has elapsed, the hairline 8 is again moved in the later direction on the time axis X. In this case, the data point count interval that was set in the numeric value inputting portion 10 is used as the movement distance for the hairline 8, and the hairline 8 stops at the plot point after the interval of that number of data points (referencing Arrow (2) shown in FIG. 13). Moreover, simultaneously with stopping the hairline 8, the data value and time mark at the plot point that is specified by the hairline 8 is displayed as numeric value information in the numeric value displaying portion 5.

Similarly, thereafter, each time the prescribed waiting time elapses, the CPU 3-1 moves the hairline 8 in the later direction on the time axis X by an interval of the number of data points set in the numeric value inputting portion 9, to stop it sequentially at plot points after spanning the interval of the number of data points. Moreover, at each of the stop locations for the hairline 8, the data value and the time mark at the plot points wherein the hairline 8 is stopped are displayed as numeric value information in the numeric value displaying portion 5.

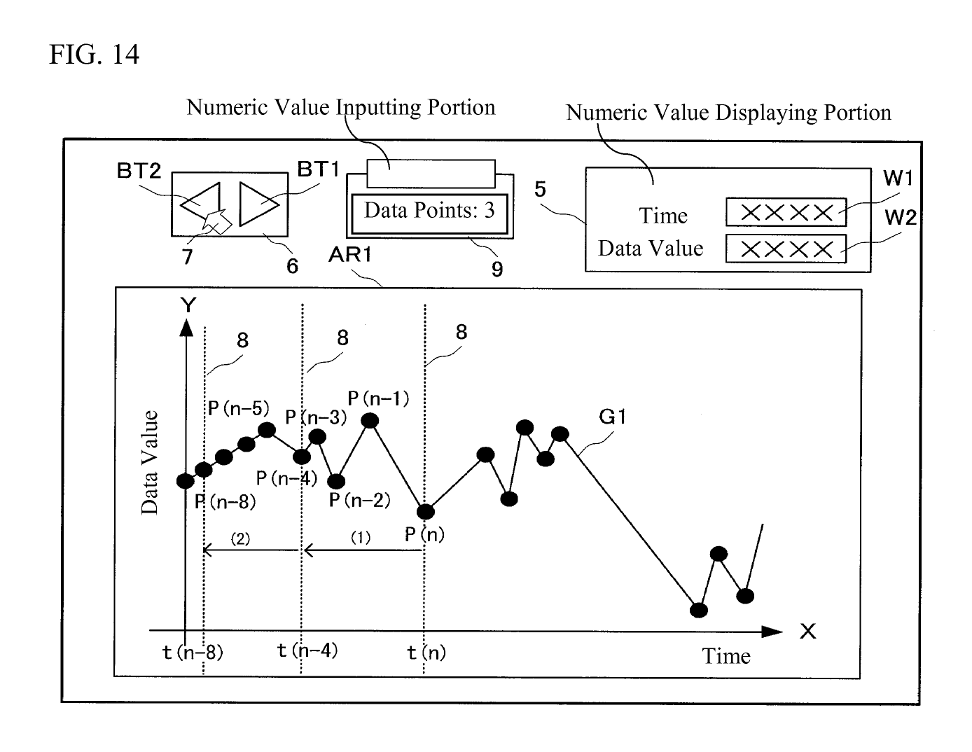

When there is a mouse click on the Back button BT2, then the CPU 3-1 detects this as an instruction from the operator to begin moving the hairline 8, specifying the earlier direction on the time axis X, and moves the hairline 8 in the earlier direction on the time axis X, specified by this instruction. In this case, the data point count interval that was set in the numeric value inputting portion 10 is used as the movement distance for the hairline 8, and the hairline 8 stops at the plot point after the interval of that number of data points (referencing Arrow (1) shown in FIG. 14). Moreover, simultaneously with stopping the hairline 8, the data value and time mark at the plot point that is specified by the hairline 8 is displayed as numeric value information in the numeric value displaying portion 5.

Given this, after the prescribed waiting time has elapsed, the hairline 8 is again moved in the earlier direction on the time axis X. In this case, the data count point interval that was set in the numeric value inputting portion 10 is used as the movement distance for the hairline 8, and the hairline 8 stops at the plot point after the interval of that number of data points (referencing Arrow (2) shown in FIG. 14). Moreover, simultaneously with stopping the hairline 8, the data value and time mark at the plot point that is specified by the hairline 8 is displayed as numeric value information in the numeric value displaying portion 5.

Similarly, thereafter, each time the prescribed waiting time elapses, the CPU 3-1 moves the hairline 8 in the earlier direction on the time axis X by an interval of the number of data points set the numeric value inputting portion 9, to stop it sequentially at plot points after spanning the interval of the number of data points. Moreover, at each of the stop locations for the hairline 8, the data value and the time mark at the plot points wherein the hairline 8 is stopped are displayed as numeric value information in the numeric value displaying portion 5.

In this way, in the Further Example, the hairline 8 is moved in the designated direction on the time axis automatically, by the data point count interval set in the numeric value inputting portion 9, through a simple mouse click on the Forward button BT1 or Back button BT2, and the hairline 8, which has been moved, sequentially stops at the plot points in the designated direction on the time axis X, where the data value and the time mark at the plot point wherein the hairline 8 is stopped are displayed as numeric value information in the numeric value displaying portion 5. In this case, it is possible to dynamically understand the movements of the plot points at the data point count interval that has been set in the trend graph G1 while observing an overall image of the trend graph G1.

Another Further Example Wherein the Hairline is Moved Automatically Sequentially to the Plot Points with Data Values Matching Prescribed Conditions

Another Further Example of the processing operations of the CPU 3-1 in accordance with a trend graph displaying program that is stored in the storage device 3-4 will be explained next. Note that in this Another Further Example as well, the “Displaying the Trend Graph” and “Displaying the Hairline” are the same as in the Example, so explanations thereof are omitted. Moreover, as with the Yet Another Example, a numeric value inputting portion 9 is displayed in the display screen for the trend graph G1 (FIG. 10).

Moving the Hairline

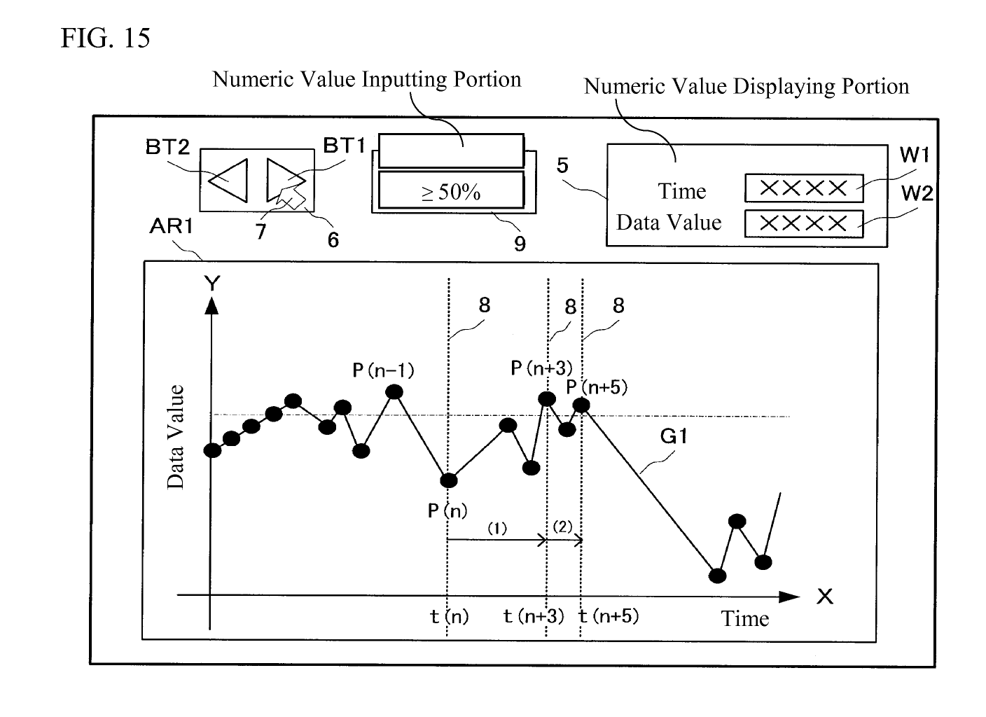

In FIG. 10, if the operator wishes to look at detailed information for the data for the next plot point, the operator inputs a data value matching a desired condition (for example: ≧50%) as the operator-designated rule (a “skip rule”) into the numeric value inputting portion 9 (referencing FIG. 15) and then performs a mouse click on the Forward button BT1 or the Back button BT2 of the operating portion 6.

For example, if the operator wishes to look at detailed data for the individual plot points in the later direction on the time axis X following the designated skip rule, the operator would perform a mouse click on the Forward button BT1, but if the operator wishes to look at detailed information for the data of the individual plot points in the earlier direction on the time axis X following the designated skip rule, the operator would perform a mouse click on the Back button BT2.

When there is a mouse click on the Forward button BT1, then the CPU 3-1 detects this as an instruction from the operator to begin moving the hairline 8, specifying the later direction on the time axis X, and moves the hairline 8 in the later direction on the time axis X, specified by this instruction. In this case, the hairline 8 that has been moved in the later direction on the time axis X is stopped at a plot point with a data value matching the conditions set in the numeric value inputting portion 9 (referencing Arrow (1) shown in FIG. 15). Moreover, simultaneously with stopping the hairline 8, the data value and time mark at the plot point that is specified by the hairline 8 is displayed as numeric value information in the numeric value displaying portion 5.

Given this, after the prescribed waiting time has elapsed, the hairline 8 is again moved in the later direction on the time axis X. In this case as well, the hairline 8 that has been moved in the later direction on the time axis X is stopped at a plot point with a data value matching the conditions set in the numeric value inputting portion 9 (referencing Arrow (2) shown in FIG. 15). Moreover, simultaneously with stopping the hairline 8, the data value and time mark at the plot point that is specified by the hairline 8 is displayed as numeric value information in the numeric value displaying portion 5.

Similarly, thereafter, each time the prescribed waiting time elapses, the CPU 3-1 moves the hairline 8 in the later direction on the time axis X, to stop it sequentially at plot points having data values that match the condition set in the numeric value inputting portion 9. Moreover, at each of the stop locations for the hairline 8, the data value and the time mark at the plot points wherein the hairline 8 is stopped are displayed as numeric value information in the numeric value displaying portion 5.

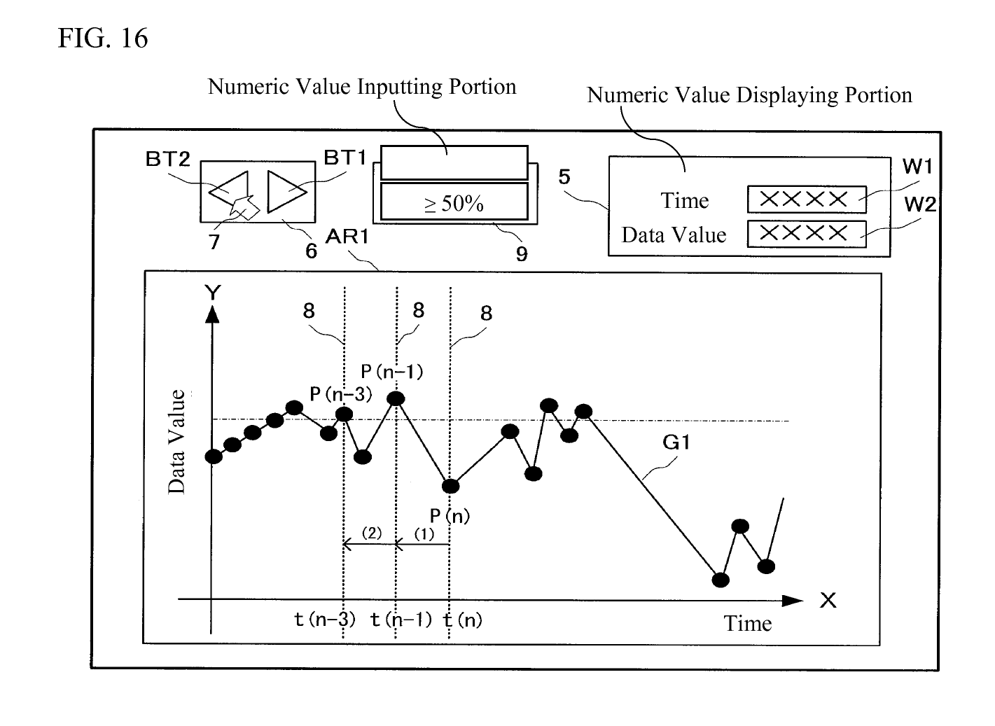

When there is a mouse click on the Back button BT2, then the CPU 3-1 detects this as an instruction from the operator to begin moving the hairline 8, specifying the earlier direction on the time axis X, and moves the hairline 8 in the earlier direction on the time axis X, specified by this instruction. In this case, the hairline 8 that has been moved in the later direction on the time axis X is stopped at a plot point with a data value matching the conditions set in the numeric value inputting portion 9 (referencing Arrow (1) shown in FIG. 16). Moreover, simultaneously with stopping the hairline 8, the data value and time mark at the plot point that is specified by the hairline 8 is displayed as numeric value information in the numeric value displaying portion 5.

Given this, after the prescribed waiting time has elapsed, the hairline 8 is again moved in the earlier direction on the time axis X. In this case as well, the hairline 8 that has been moved in the earlier direction on the time axis X is stopped at a plot point with a data value matching the conditions set in the numeric value inputting portion 9 (referencing Arrow (2) shown in FIG. 16). Moreover, simultaneously with stopping the hairline 8, the data value and time mark at the plot point that is specified by the hairline 8 is displayed as numeric value information in the numeric value displaying portion 5.

Similarly, thereafter, each time the prescribed waiting time elapses, the CPU 3-1 moves the hairline 8 in the earlier direction on the time axis X, to stop it sequentially at plot points having data values that match the condition set in the numeric value inputting portion 9. Moreover, at each of the stop locations for the hairline 8, the data value and the time mark at the plot points wherein the hairline 8 is stopped are displayed as numeric value information in the numeric value displaying portion 5.

In this way, in the Another Further Example, the hairline 8 is moved in the designated direction on the time axis automatically, to plot points having data values matching the condition set in the numeric value inputting portion 9, through a simple mouse click on the Forward button BT1 or Back button BT2, and the hairline 8, which has been moved, sequentially stops at the plot points in the designated direction on the time axis X, where the data value and the time mark at the plot point wherein the hairline 8 is stopped are displayed as numeric value information in the numeric value displaying portion 5. In this case, it is possible to extract only those plot points with data values matching the desired condition, to dynamically understand the movements of the plot points in the trend graph G1 while observing an overall image of the trend graph G1.

As explained above, through showing the Example through the Another Further Example as typical examples, the operator, through the simple operation of mouse clicking the Forward button BT1 and the Back button BT2 of the operating portion 6, is able to look at the detailed data at individual plot points by reliably indicating data for those individual plot points while still displaying the entirety of the trend graph G1, thus eliminating complex and troublesome operations and enabling the operations in checking the data of the individual plot points to be performed efficiently. Moreover, because the hairline 8 automatically moves and stops on the plot points in the trend graph G1, it is possible to check the data of the plot points on the trend graph G1 reliably, even without an awareness of irregular data collection intervals, making it possible to reduce omissions in checking

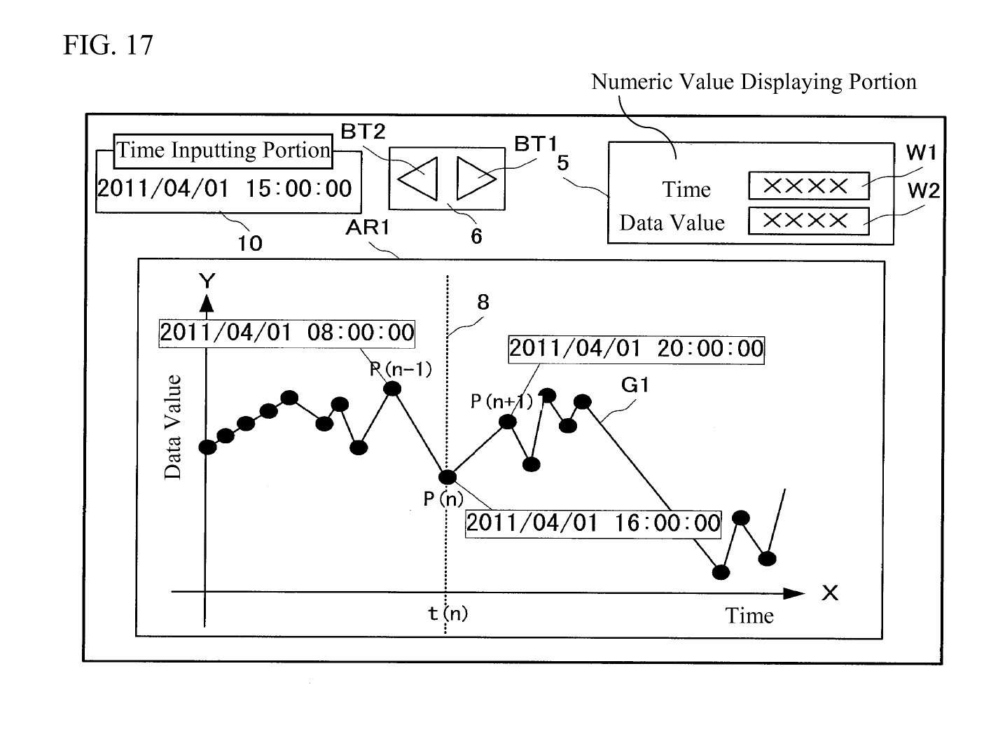

Note that while in the Example through the Another Further Example, set forth above, the hairline 8 was displayed for a plot point when the mouse cursor 7 was positioned at a location wherein a desired plot point exists, instead, as illustrated in FIG. 17, a time mark inputting portion 10 may be provided, and the hairline 8 may be displayed for the plot point of the time mark that is nearest to a time mark that is set in the time mark inputting portion 10.

In this example, “2011/04/01 15:00:00” is set as the time mark in the time mark inputting portion 10. Doing so causes the CPU 3-1 to display the hairline 8 relative to the plot point P(n) of “2011/04/01 16:00:00,” as the plot point in the trend graph G1 having the smallest time difference from the time mark set in the time mark inputting portion 10.

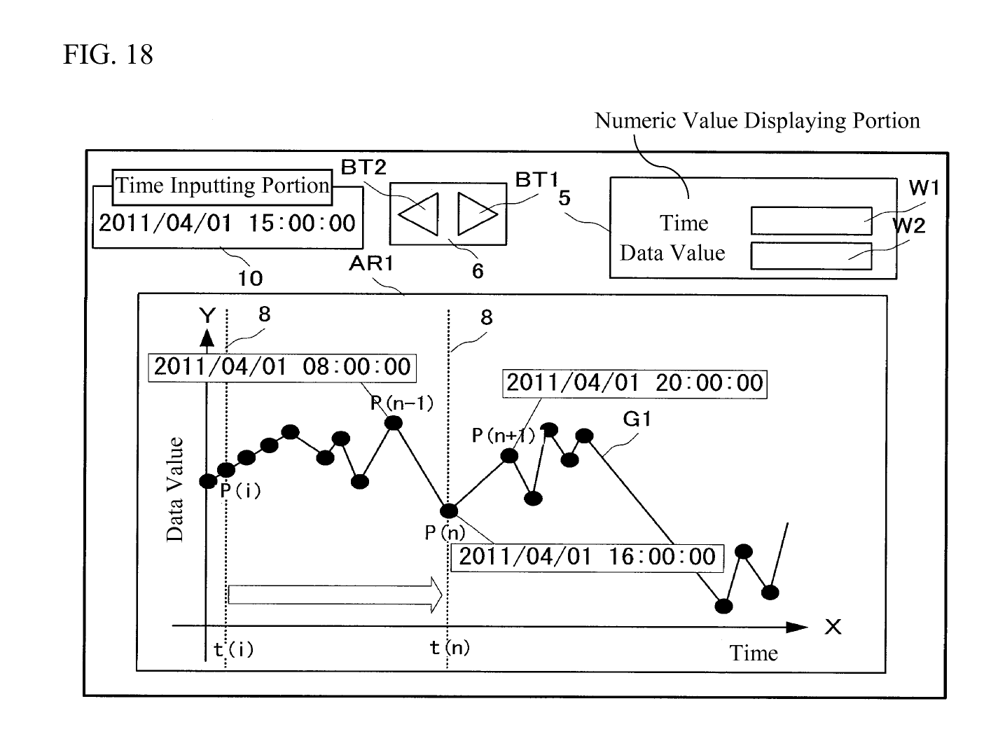

Moreover, as illustrated in FIG. 18, in the example wherein this time mark inputting portion 10 is provided, a time mark can be set in the time mark inputting portion 10 from the state wherein the hairline 8 is displayed at a plot point P(i), to move the hairline 8 to the plot point of the time mark that is nearest to the time mark set in this time mark inputting portion 10.

In this example, “2011/04/01 15:00:00” is set as the time mark in the time mark inputting portion 10. Doing so causes the CPU 3-1 to move the hairline 8 to the plot point P(n) of “2011/04/01 16:00:00,” as the plot point in the trend graph G1 having the smallest time difference from the time mark inputted in the time mark inputting portion 10.

In this way, in the example wherein the time mark inputting portion 10 is provided, the hairline 8 can be displayed at the appropriate plot point, and can be moved, through setting a rough time mark, thus making it easy for even an operator who is unaware of the collection schedule for the time series data to find target data.

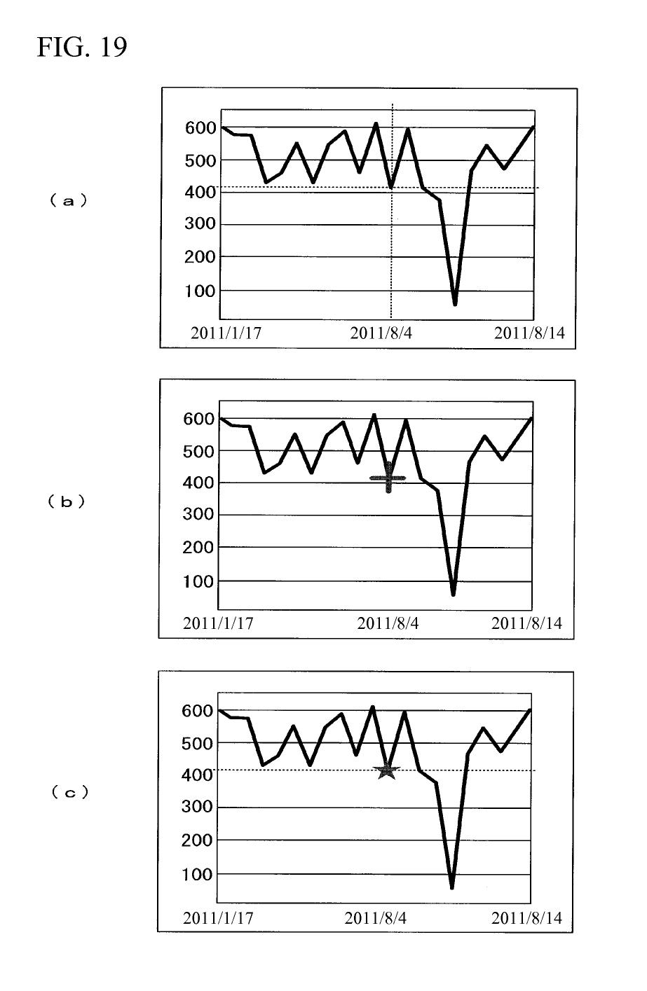

Moreover, while in the Example through the Another Further Example, set forth above, a hairline 8 was displayed as the focus data pointer, the hairline 8 is not necessarily a vertical line, but rather may be a horizontal line or may be both a vertical line and a horizontal line (referencing FIG. 19 (a)). Moreover, insofar as it is possible to identify that a plot point is being indicated, it may be a + symbol, as illustrated in FIG. 19 (b), a star mark as illustrated in FIG. 19 (c), or the like.

Moreover, while in the Example through the Another Further Example, set forth above, an operating portion 6 comprising the Forward button BT1 and the Back button BT2 was provided, the functions of the Forward button BT1 and the Back button BT2 may be assigned to arrow keys on the keyboard 3-9, and these arrow keys may be operated to apply the instruction to begin moving in the earlier or later direction on the time axis X.

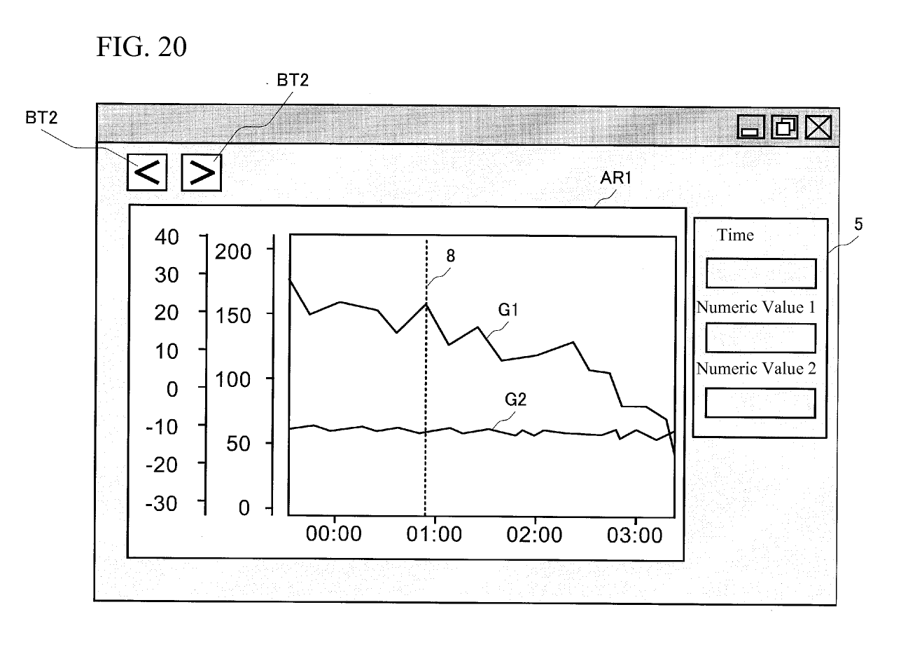

Moreover, while, for simplicity in the explanation, only a single trend graph was displayed in the Example through the Another Further Example, set forth above, a plurality of trend graphs may be displayed instead. For example, as illustrated in FIG. 20, a plurality of time series data having identical collection time marks may be displayed on the same screen as trend graphs G1 and G2, and the hairline 8 may be displayed relative to the trend graphs G1 and G2. In this case, the data values and time marks for the individual plot points of the trend graphs G1 and G2, indicated by the hairline 8, will be displayed in the numeric value displaying portion 5.

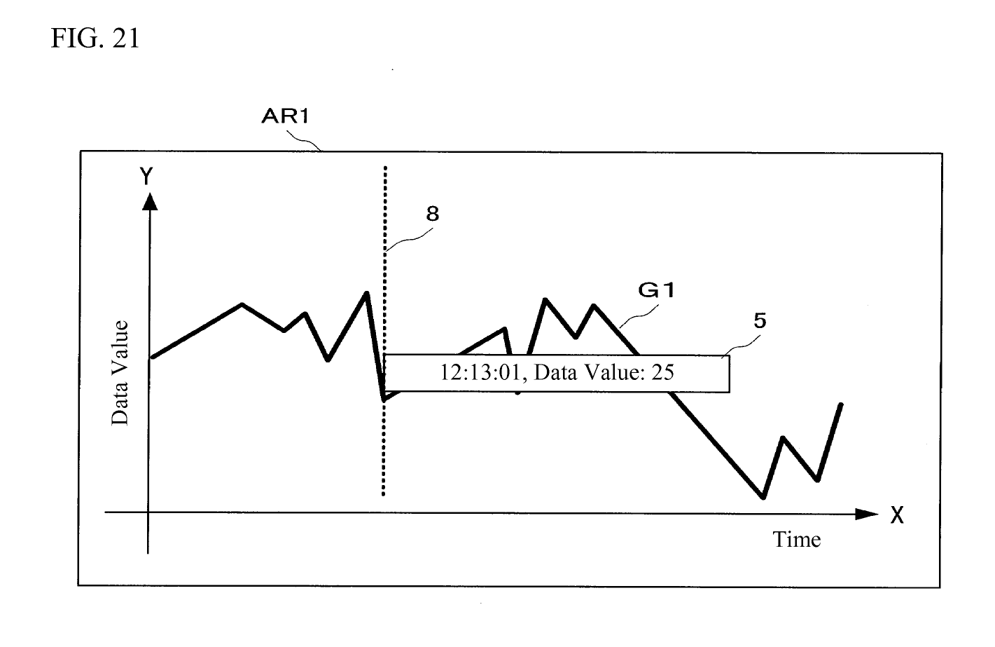

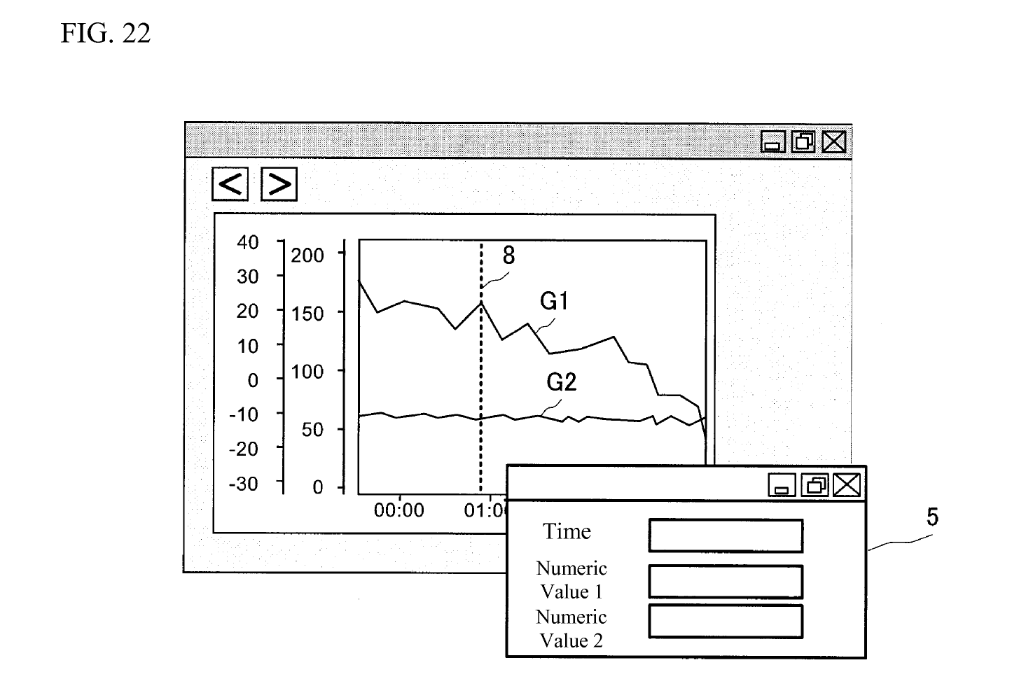

In addition, while in the Example through the Another Further Example, set forth above, a numeric value displaying portion 5 was provided to the outside of the display area AR1 for the trend graph G1, instead a tooltip may be displayed, within the graph, as the numeric value displaying portion 5 (referencing FIG. 21), or a screen that is separate from the display screen for the trend graph G1 may be displayed as the numeric value displaying portion 5 (referencing FIG. 22).

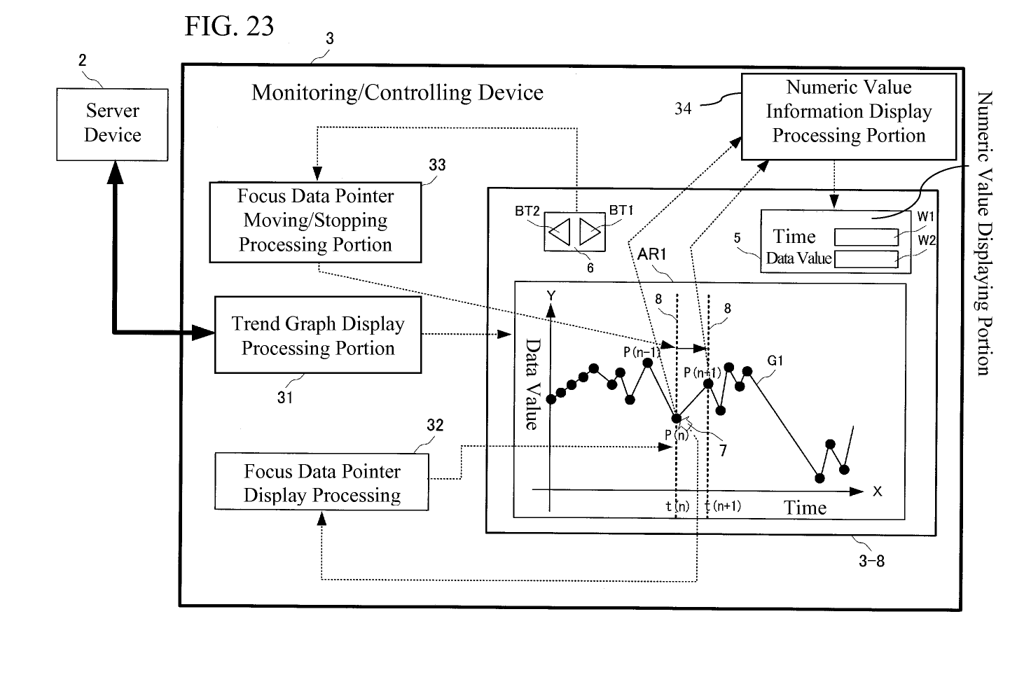

FIG. 23 shows a functional block diagram of the monitoring/controlling device 3 set forth above. The monitoring/controlling device 3 comprises: a trend graph display processing portion 31 for plotting time series data in an orthogonal plane indicated by a time axis X and a data axis Y, using the horizontal axis as the time axis X for indicating time marks and the vertical axis, which is perpendicular to the time axis X, as the data axis Y for indicating data values, and for connecting together, with graph lines, the plotted time series data to display it as a trend graph G1 on a display 3-8; a focus data pointer display processing portion 32 for displaying, as a focus data pointer, a hairline 8 indicating a plot point, for a selectively indicated plot point in the time series when a desired plot point in the time series data has been selectively indicated on the trend graph G1; a focus data pointer moving/stopping processing portion 33 for receiving an instruction from an operator to start moving the hairline 8, specifying the earlier or later direction on the time axis X, for moving the hairline 8 in the earlier or later direction on the time axis X, specified by the instruction, and for stopping the hairline 8, which has been moved, at a plot point in the time series data on the trend graph G1; and a numeric value information display processing portion 34 for displaying, in a numeric value displaying portion 5, a data value and a time mark at the plot point of the time series data indicated by the hairline 8, as numeric value information.

In the Example, the focus data pointer moving/stopping processing portion 33 receives, from the operator, an instruction to start movement of the hairline 8, specifying the earlier or later direction on the time axis X, where this instruction causes movement of the hairline 8 in the earlier or later direction, specified by the instruction, on the time axis X, and stops the hairline 8, which has been moved, at the nearest plot point of the time series data on the trend graph G1.

In the Another Example, the focus data pointer moving/stopping processing portion 33 receives, from the operator, an instruction to start movement of the hairline 8, specifying the earlier or later direction on the time axis X, where this instruction causes movement of the hairline 8 in the earlier or later direction, specified by the instruction, on the time axis X, and sequentially stops, in time series order, the hairline 8, which has been moved, at the plot points of the time series data on the trend graph G1.

In the Yet Another Example, the focus data pointer moving/stopping processing portion 33 receives, from the operator, an instruction to start movement of the hairline 8, specifying the earlier or later direction on the time axis X, where this instruction causes movement of the hairline 8 in the earlier or later direction, specified by the instruction, on the time axis X, and sequentially stops the hairline 8, which has been moved, at the nearest plot points, with the time interval that has been set, in the time series data on the trend graph G1.

In the Further Example, the focus data pointer moving/stopping processing portion 33 receives, from the operator, an instruction to start movement of the hairline 8, specifying the earlier or later direction on the time axis X, where this instruction causes movement of the hairline 8 in the earlier or later direction, specified by the instruction, on the time axis X, and sequentially stops the hairline 8, which has been moved, at plot points with the data point count interval that has been set in the time series data on the trend graph G1.

In the Another Further Example, the focus data pointer moving/stopping processing portion 33 receives, from the operator, an instruction to start movement of the hairline 8, specifying the earlier or later direction on the time axis X, where this instruction causes movement of the hairline 8 in the earlier or later direction, specified by the instruction, on the time axis X, and sequentially stops the hairline 8, which has been moved, at those plot points with data values that match the prescribed condition that has been set, of the time series data on the trend graph G1.

### Other Examples

While the present invention has been explained above in reference to the examples, the present invention is not limited to the examples set forth above. The structures and details in the present invention may be varied in a variety of ways, as can be understood by one skilled in the art, within the scope of technology in the present invention. Moreover, the present invention may be embodied through combining the various examples, insofar as there are no contradictions.

1. A graph displaying device comprising:
a trend graph display that defines a first axis as a time axis to indicate time marks, defines a second axis that is perpendicular to the first axis as a data axis to indicate data values, and plots time series data in an orthogonal plane indicated by the first axis and the second axis, to display the plotted time series data as a trend graph;
a focus data pointer display that displays, as a focus data pointer, a pointer to indicate a plot point relative to a selectively indicated plot point of the time series data when a desired plot point of the time series data has been selectively indicated on the trend graph;
a focus data pointer moving/stopping unit that receives an instruction from an operator for starting movement of the focus data pointer in a designated earlier or later direction on the first axis, moves the focus data pointer in the earlier or later direction, designated by the instruction on the first axis, and stops, at a plot point of the time series data on the trend graph, the focus data pointer that has been moved; and
a numeric value information display that displays as numeric value information a data value and a time mark at the plot point of the time series data indicated by the focus data pointer.

2. The graph displaying device as set forth in claim 1, wherein:
the focus data pointer moving/stopping unit stops, at the nearest plot point of the time series data on the trend graph, the focus data pointer that has been moved.

3. The graph displaying device as set forth in claim 1, wherein:
the focus data pointer moving/stopping unit stops, sequentially, in time series order, at plot points of the time series data on the trend graph, the focus data pointer that has been moved.

4. The graph displaying device as set forth in claim 1, wherein:
the focus data pointer moving/stopping unit stops, sequentially at plot points of the time series data on the trend graph, the focus data pointer that has been moved, following a prescribed rule.

5. The graph displaying device as set forth in claim 4, wherein:
the focus data pointer moving/stopping unit uses a prescribed time interval for the prescribed rule to stop, or sequentially stop, the focus data pointer that has been moved at the nearest plot points, in the time series data on the trend graph, with the prescribed time interval set as the prescribed rule.

6. The graph displaying device as set forth in claim 4, wherein:
the focus data pointer moving/stopping unit uses a prescribed data point count interval for the prescribed rule to stop, or sequentially stop, the focus data pointer that has been moved at plot points, in the time series data on the trend graph, with the prescribed data point count interval set as the prescribed rule.

7. The graph displaying device as set forth in claim 4, wherein:
the focus data pointer moving/stopping unit uses a data value matching a prescribed condition for the prescribed rule to stop, or sequentially stop, the focus data pointer that has been moved at those plot points, in the time series data on the trend graph, that have data values matching the prescribed condition set as the prescribed rule.

8. The graph displaying device as set forth in claim 4, further comprising:
a condition inputting unit in which a rule designated by a user is set as the prescribed rule.
